(19) United States
(12) Patent Application Publication
(10) Pub. No.: US 2006/0055657 A1
(43) Pub. Date: Mar. 16, 2006

(54) Display apparatus, display control method , program and recording medium

(75) Inventors: Noriyuki Koyama, Kyoto (JP); Satoshi Okada, Kyoto (JP); Yoshimi Asai, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 10/521,448

(22) PCT Filed: Jul. 14, 2003
(86) PCT No.: PCT/JP03/08935

§ 371 Date: Aug. 11, 2005

(30) Foreign Application Priority Data
Jul. 16, 2002 (JP) 2002-207561

(51) Int. Cl. G09G 3/36

(52) U.S. Cl. 345/102

(57) ABSTRACT

A display apparatus is provided, which comprises a display device including a display screen for displaying characters and/or graphics, in which each of the characters and/or graphics contains a basic portion and a neighboring portion arranged in the vicinity of the basic portion, and a control section for controlling the display device. The control section sets a luminance level of the basic portion and a luminance level of the neighboring portion in accordance with the intensity of light for irradiating the display screen. The control section controls the display device so that the character and/or graphics are displayed on the display screen using the set luminance level of the basic portion and the set luminance level of the neighboring portion.

### TECHNICAL FIELD

The present invention relates to a display apparatus, a display control method, and a program and recording medium thereof.

### BACKGROUND ART

A conventional display apparatus for displaying characters and the like using a display device capable of color display is known as described in, for example, Japanese Laid-Open Publication No. 2001-100725 where a “character display apparatus” is disclosed.

Characters displayed by the “character display apparatus” are each made of a basic portion corresponding to the core (central skeleton) of the character and a neighboring portion arranged in the vicinity of the basic portion. The character display apparatus has a display screen containing a plurality of pixels, each of which contains a plurality of subpixels. The basic portion and neighboring portion of a character are assigned different subpixels.

In the character display apparatus, while the color element levels of the subpixels of a basic portion are set to a predetermined luminance level, the color element levels of the subpixels of the neighboring portion are set to a luminance level different from that of the basic portion. The number of subpixels and the color element levels of the subpixels in the neighboring portion are determined in accordance with a correction pattern.

FIG. 12 is a diagram showing a character “/” (slash) displayed by a character display apparatus as disclosed in Japanese Laid-Open Publication No. 2001-100725, where the character “/” is represented only by the basic portion whose color element level is set to a predetermined luminance level.

Hatched rectangles in FIG. 12 represent subpixels corresponding to the basic portion of the character “/” (slash). When the color element level of a subpixel is set to a luminance level ranging from 0 to 255, the color element levels of subpixels corresponding to the basic portion of the character “/” are set to, for example, a luminance level “0”.

On the other hand, open rectangles represent subpixels corresponding to the background of the character “/”. The color element levels of the subpixels corresponding to the background of the character “/” are set to a luminance level “255”.

FIG. 13 is a diagram showing the character “/” (slash) displayed by a character display apparatus as disclosed in Japanese Laid-Open Publication No. 2001-100725, where the color element level of the basic portion is set to a predetermined luminance level (luminance level 0) and the color element level of the neighboring portion(s) is set to a luminance level different from the luminance level (“0”) of the basic portion.

In FIG. 13, neighboring portions on each lateral side of each of the subpixels corresponding to the basic portion of the character “/” are set to “luminance level 73”, “luminance level 182”, and “luminance level 219” in order of distance from the basic portion, the nearest first, in accordance with a predetermined correction pattern.

Note that “assign luminance levels to the color element levels of subpixels of a neighboring portion in accordance with a correction pattern” is referred to as “provide a correction pattern”.

The purposes of provision of a correction pattern include: suppression of color noise; recognition of characters or graphics as being black by human eyes; and adjustment of the apparent thickness of characters to a desired size.

Thus, according to the “character display apparatus” of Japanese Laid-Open Publication No. 2001-100725, characters can be displayed with high definition by providing the correction pattern for subpixels neighboring subpixels corresponding to the basic portion of a character.

Further, in the character display apparatus of Japanese Laid-Open Publication No. 2001-100725, subpixels corresponding to the basic portion are determined based on character outline information indicating the outlines of characters or skeleton data indicating the skeletal shapes of characters.

The character outline information includes character codes for identifying the types of characters, the number of strokes constituting each character (the stroke count of a character), and stroke information on each stroke.

The stroke information includes stroke codes for identifying a plurality of strokes, the number of contour points constituting each stroke, and a pointer for the coordinate data of contour points constituting each stroke (an address in an auxiliary memory device at which the coordinates of the contour points constituting the stroke are stored). From this information, the coordinates of the contour points constituting a stroke can be obtained. In this case, each stroke has a shape enclosed by a contour line approximated by curved lines, straight lines, arcs, a combination thereof, or the like, and a predetermined thickness so as to display the contour shape of a character.

A contour line representing the contour shape of a character can be approximated by straight lines, curved lines, arcs, a combination thereof, or the like, using the coordinate data of contour points. The contour line is scaled in accordance with the size of an input character. This scaling converts the coordinate data of contour points to a coordinate system for a display device. A sub-pixel is determined as corresponding to a basic portion representing the core of a character depending on an area where a region enclosed by a contour line overlaps a sub-pixel, for example, if the area is greater than or equal to a predetermined area.

Skeleton data includes character codes for identifying the type of character, the number of strokes constituting each character, and stroke information on each stroke.

The stroke information includes stroke numbers for identifying respective strokes, the number of points constituting each stroke, the line type of each stroke (curved line, straight line, or the like), the coordinates of points constituting each stroke, and the like. In this case, each stroke does not have a thickness and is in the form of a line of a certain line type corresponding to the basic portion of a character.

If the line type of a stroke is a straight line, the stroke can be approximated by a straight line passing through the coordinate data of a plurality of points constituting the stroke. If the line type of a stroke is a curved line, the stroke can be approximated by a curved line passing through the coordinate data of a plurality of points constituting the stroke.

The coordinate data of points constituting each stroke is scaled in accordance with the size of an input character and is converted into a coordinate system for a display device. Subpixels present on each scaled stroke are determined as subpixels corresponding to a basic portion representing the core (skeletal shape) of a character.

Japanese Laid-Open Publication No. 2002-49366 discloses a technique for associating a basic portion of a character or graphics with subpixels using bitmap data. This technique will be described in detail below.

Bitmap data contains a plurality of bits arranged in a matrix of a plurality of rows and a plurality of columns.

Bitmap data is binary data containing bits. Each of the bits constituting bitmap data has a value of “1” or “0”. A bit having a value of “1” indicates, for example, a black color, while a bit having a value of “0” indicates a white color.

It is determined whether or not each of bits constituting bitmap data has a value of “1”. An arrangement pattern of “1”/“0” values of bits neighboring a bit of interest is investigated. The bit of interest is associated with a pixel of a display screen. Based on the arrangement pattern of neighboring bits, subpixel (s) corresponding to the basic portion are determined from among the subpixels contained in a pixel corresponding to the bit of interest.

A “display apparatus” which controls the luminance of a display device in accordance with a surrounding environment, is disclosed in Japanese Laid-Open Publication No. 6-214508.

In this “display apparatus”, a sensor for sensing ambient brightness is provided in the vicinity of the display device. By adjusting the luminance and contrast of the entire display device in accordance with the ambient brightness sensed by the sensor, the screen display can be made more viewable.

When the above-described conventional “character display apparatus” disclosed in Japanese Laid-Open Publication No. 2001-100725 is used under conditions that brightness is uniform (e.g., the apparatus is used as a liquid crystal display device for a notebook type personal computer), characters do not suffer from the color noise problem.

However, it is conceived that the above-described “character display apparatus” can be used under conditions wherein brightness is not uniform.

Brightness is not uniform, for example, when the above-described “character display apparatus” is used as the liquid crystal display device of a mobile telephone.

In liquid crystal display devices, when the surrounding environment is dark, the backlight is turned on so that the display screen is irradiated by the backlight and display is performed in a transmission mode. When the surrounding environment is bright, the backlight is turned off for the purpose of reduction of power consumption. In this case, ambient light incoming to the display screen is reflected by the reflection portion so that display is performed in a reflection mode. Thus, an arrangement which controls display by switching the two modes, is known. In this arrangement, the characteristics of the device are changed depending on the on/off state of the backlight.

Therefore, if correction patterns are predetermined so as to be suitable for the case where the backlight is turned on, the correction pattern is conspicuous as color noise when the backlight is turned off. Further, when the backlight is turned off, the thickness of a character may be perceived on the dark display screen as being greater than that which is perceived when the backlight is turned on.

On the other hand, if correction patterns are predetermined so as to be suitable for the case where the backlight is turned off, the correction pattern is conspicuous as color noise when the backlight is turned on. Further, when the backlight is turned on, the thickness of a character may be perceived on the bright display screen as being smaller than that which is perceived when the backlight is turned off.

Some recent mobile telephones can adjust the brightness (irradiation level) of the backlight in a stepwise manner rather than simply switching the backlight on/off. Also in this case, similarly, color noise occurs and/or a change in the apparent thickness of a character occurs, depending on the brightness of the backlight.

The above-described problems also occur in the case of a frontlight or a sidelight in addition to a backlight.

A display apparatus utilizing a frontlight has the following structure and function. The frontlight is provided at a front side of a display screen. When the surrounding environment is bright, the frontlight is turned off so that ambient light incoming to the display screen is reflected by the reflection portion and display performed in a reflection mode. When the surrounding environment is dark, the frontlight is turned off and the display screen is irradiated by the frontlight so that display is performed in the transmission mode. In this case, the above-described problem occurs similarly.

A display apparatus utilizing a side light has the following structure and function. The light guide board is provided on the front or back sides of a display screen. A sidelight is provided at an end of the light guide board so as to irradiate the display screen via the light guide board. When the surrounding environment is bright, the sidelight is turned off, and ambient light incoming to the display screen is reflected by a reflection portion so that display is performed in a reflection mode. When the surrounding environment is dark, the sidelight is turned on and the display screen is irradiated by the sidelight so that display is performed in a transmission mode. In this case, the above-described problem occurs similarly.

In the “display apparatus” disclosed in Japanese Laid-Open Publication No. 6-214508, the luminance and contrast of the display device are adjusted depending on the brightness of the surrounding environment. Therefore, images and videos are easily viewable on the entire display screen. However, characters displayed on the display screen are not always easily viewable.

In the case of this display apparatus in which luminance and contrast are adjusted over the display device, it is difficult to suppress color noise and/or a change in the apparent thickness of a character by the above-described display control method used in the “character display apparatus” disclosed in Japanese Laid-Open Publication No. 2001-100725, in which a correction pattern is provided for each subpixel so as to display characters or graphics. Further, since a display device is controlled depending on the brightness of the surrounding environment, a sensor has to be provided around the display device.

### DISCLOSURE OF THE INVENTION

According to an aspect of the present invention, a display apparatus is provided, which comprises: a display device including a display screen for displaying characters and/or graphics, in which each of the characters and/or graphics contains a basic portion and a neighboring portion arranged in the vicinity of the basic portion; and a control section for controlling the display device. The control section sets a luminance level of the basic portion and a luminance level of the neighboring portion in accordance with the intensity of light for irradiating the display screen. The control section controls the display device so that the character and/or graphics are displayed on the display screen using the set luminance level of the basic portion and the set luminance level of the neighboring portion.

In one embodiment of this invention, the control section corrects at least one of the luminance level of the basic portion and the luminance level of the neighboring portion in accordance with the intensity of light for irradiating the display screen.

In one embodiment of this invention, the control section sets the luminance level of the neighboring portion so that the luminance level of the neighboring portion is changed stepwise with an increase in a distance from the basic portion.

In one embodiment of this invention, the control section sets the luminance level of the basic portion and the luminance level of the neighboring portion based on luminance levels of a plurality of color elements.

In one embodiment of this invention, the display screen contains a plurality of pixels; each of the plurality of pixels contains a plurality of subpixels; and each of the plurality of subpixels is associated with one of a plurality of color elements.

In one embodiment of this invention, the basic portion and the neighboring portion are assigned the plurality of subpixels.

In one embodiment of this invention, the display apparatus further comprises a light irradiation section for irradiating the display screen with light. The control section sets the luminance level of the basic portion and the luminance level of the neighboring portion in accordance with the intensity of light to be emitted from the light irradiation section to the display screen.

In one embodiment of this invention, the control section sets the luminance level of the basic portion and the luminance level of the neighboring portion in accordance with the on or off state of the light irradiation section.

In one embodiment of this invention, the control section sets the luminance level of the basic portion and the luminance level of the neighboring portion in accordance with an irradiation level indicating the intensity of light to be emitted from the light irradiation section to the display screen.

In one embodiment of this invention, the display apparatus further comprises a light irradiation section for irradiating the display screen with light. The display device includes a display medium and a reflection section. The light irradiation section is disposed at a rear of the display medium. The control section switches between a transmission mode in which light to be emitted from the light irradiation section is transmitted through the display medium when the light irradiation section is on, and a reflection mode in which light incident from a front of the display medium and transmitted through the display medium is reflected by the reflection section when the light irradiation section is off. The control section sets the luminance level of the basic portion and the luminance level of the neighboring portion in accordance with the transmission mode or the reflection mode.

In one embodiment of this invention, the display apparatus further comprises a memory section for storing a plurality of correction pattern tables indicating the luminance level of the basic portion and the luminance level of the neighboring portion. The control section selects one of the plurality of correction pattern tables in accordance with the intensity of light for irradiating the display screen, and sets the luminance level of the basic portion and the luminance level of the neighboring portion in accordance with the selected correction pattern table.

In one embodiment of this invention, the plurality of correction pattern tables are dependent on the intensity of light for irradiating the display screen.

In one embodiment of this invention, the display apparatus further comprises an input section for setting the intensity of light to be emitted from the light irradiation section.

In one embodiment of this invention, the display apparatus further comprises an input section for inputting information related to a viewer viewing the display device.

In one embodiment of this invention, the viewer-related information includes at least one of information related to the viewer's age, information related to the viewer's eye condition, and information related to the viewer's preference.

According to another aspect of the present invention, a display control method for displaying characters and/or graphics on a display screen is provided, in which each of the characters and/or graphics contains a basic portion and a neighboring portion arranged in the vicinity of the basic portion. The method comprises the steps of: setting a luminance level of the basic portion and a luminance level of the neighboring portion in accordance with the intensity of light for irradiating the display screen; and displaying the character and/or graphics on the display screen using the set luminance level of the basic portion and the set luminance level of the neighboring portion.

In one embodiment of this invention, the setting step includes correcting at least one of the luminance level of the basic portion and the luminance level of the neighboring portion in accordance with the intensity of light for irradiating the display screen.

In one embodiment of this invention, the setting step includes setting the luminance level of the neighboring portion so that the luminance level of the neighboring portion is changed stepwise with an increase in a distance from the basic portion.

In one embodiment of this invention, the setting step includes setting the luminance level of the basic portion and the luminance level of the neighboring portion based on luminance levels of a plurality of color elements.

In one embodiment of this invention, the display screen contains a plurality of pixels; each of the plurality of pixels contains a plurality of subpixels; and each of the plurality of subpixels is associated with one of a plurality of color elements.

In one embodiment of this invention, the display control method further comprises the step of setting the intensity of light to be emitted from a light irradiation section to the display screen. The step of setting the luminance levels includes setting the luminance level of the basic portion and the luminance level of the neighboring portion in accordance with the set intensity of light to be emitted from the light irradiation section to the display screen.

According to another aspect of the present invention, a program for displaying characters and/or graphics on a display screen is provided, in which each of the characters and/or graphics contains a basic portion and a neighboring portion arranged in the vicinity of the basic portion. The program instructs a computer to execute the steps of: setting a luminance level of the basic portion and a luminance level of the neighboring portion in accordance with the intensity of light for irradiating the display screen; and displaying the character and/or graphics on the display screen using the set luminance level of the basic portion and the set luminance level of the neighboring portion.

According to another aspect of the present invention, a recording medium, storing a program for displaying characters and/or graphics on a display screen, is provided, in which each of the characters and/or graphics contains a basic portion and a neighboring portion arranged in the vicinity of the basic portion. The program instructs a computer to execute the steps of: setting a luminance level of the basic portion and a luminance level of the neighboring portion in accordance with the intensity of light for irradiating the display screen; and displaying the character and/or graphics on the display screen using the set luminance level of the basic portion and the set luminance level of the neighboring portion.

According to another aspect of the present invention, a display apparatus is provided, which comprises: a display device including a display screen for displaying characters and/or graphics, in which each of the characters and/or graphics contains a basic portion and a neighboring portion arranged in the vicinity of the basic portion; and a control section for controlling the display device. The control section sets a luminance level of the basic portion and a luminance level of the neighboring portion in accordance with information related to a viewer of the display device. The control section controls the display device so that the character and/or graphics are displayed on the display screen using the set luminance level of the basic portion and the set luminance level of the neighboring portion.

In one embodiment of this invention, the control section corrects at least one of the luminance level of the basic portion and the luminance level of the neighboring portion in accordance with the viewer-related information.

In one embodiment of this invention, the viewer-related information includes at least one of information related to the viewer's age, information related to the viewer's eye condition, and information related to the viewer's preference.

In one embodiment of this invention, the control section sets the luminance level of the neighboring portion so that the luminance level of the neighboring portion is changed stepwise with an increase in a distance from the basic portion.

In one embodiment of this invention, the control section sets the luminance level of the basic portion and the luminance level of the neighboring portion based on luminance levels of a plurality of color elements.

In one embodiment of this invention, the display screen contains a plurality of pixels; each of the plurality of pixels contains a plurality of subpixels; and each of the plurality of subpixels is associated with one of a plurality of color elements.

In one embodiment of this invention, the basic portion and the neighboring portion are assigned the plurality of subpixels.

In one embodiment of this invention, the display apparatus further comprises a memory section for storing a plurality of correction pattern tables indicating the luminance level of the basic portion and the luminance level of the neighboring portion. The control section selects one of the plurality of correction pattern tables in accordance with the viewer-related information, and sets the luminance level of the basic portion and the luminance level of the neighboring portion in accordance with the selected correction pattern table.

In one embodiment of this invention, the display apparatus further comprises an input section for inputting the viewer-related information.

According to another aspect of the present invention, a display control method for displaying characters and/or graphics on a display screen is provided, in which each of the characters and/or graphics contains a basic portion and a neighboring portion arranged in the vicinity of the basic portion. The method comprises the steps of: setting a luminance level of the basic portion and a luminance level of the neighboring portion in accordance with information related to a viewer of the display screen; and displaying the character and/or graphics on the display screen using the set luminance level of the basic portion and the set luminance level of the neighboring portion.

In one embodiment of this invention, the setting step includes correcting at least one of the luminance level of the basic portion and the luminance level of the neighboring portion in accordance with the viewer-related information.

In one embodiment of this invention, the viewer-related information includes at least one of information related to the viewer's age, information related to the viewer's eye condition, and information related to the viewer's preference.

In one embodiment of this invention, the setting step includes setting the luminance level of the neighboring portion so that the luminance level of the neighboring portion is changed stepwise with an increase in a distance from the basic portion.

In one embodiment of this invention, the setting step includes setting the luminance level of the basic portion and the luminance level of the neighboring portion based on luminance levels of a plurality of color elements.

In one embodiment of this invention, the display screen contains a plurality of pixels; each of the plurality of pixels contains a plurality of subpixels; and each of the plurality of subpixels is associated with one of a plurality of color elements.

In one embodiment of this invention, the display control method further comprises the step of inputting the viewer-related information.

According to another aspect of the present invention, a program for displaying characters and/or graphics on a display screen is provided, in which each of the characters and/or graphics contains a basic portion and a neighboring portion arranged in the vicinity of the basic portion. The program instructs a computer to execute the steps of: setting a luminance level of the basic portion and a luminance level of the neighboring portion in accordance with information related to a viewer of the display screen; and displaying the character and/or graphics on the display screen using the set luminance level of the basic portion and the set luminance level of the neighboring portion.

According to another aspect of the present invention, a recording medium, storing a program for displaying characters and/or graphics on a display screen, is provided, in which each of the characters and/or graphics contains a basic portion and a neighboring portion arranged in the vicinity of the basic portion. The program instructs a computer to execute the steps of: setting a luminance level of the basic portion and a luminance level of the neighboring portion in accordance with information related to a viewer of the display screen; and displaying the character and/or graphics on the display screen using the set luminance level of the basic portion and the set luminance level of the neighboring portion.

Functions of the present invention will be described below.

According to the present invention, the luminance levels of the basic portion and the neighboring portion of a character and/or graphics can be set in accordance with the intensity of light for irradiating the display screen.

The intensity of light for irradiating the display screen varies depending on the on/off state of the light irradiation section. The intensity of light for irradiating the display screen also varies depending on the irradiation level of the light irradiation section.

For example, by switching between a correction pattern suitable for the on state of the light irradiation section and a correction pattern suitable for the off state of the light irradiation section in accordance with a change in the characteristic of the display device caused by the switching of the on/off state of the light irradiation section (e.g., a backlight, a frontlight, or a sidelight), color noise can be suppressed and a change in the apparent thickness of a line of a character and/or graphics can be suppressed.

When the irradiation level of the light irradiation section (e.g., a backlight, a frontlight, or a sidelight) is changed in a stepwise manner, a correction pattern is changed in accordance with the irradiation level (brightness) of the light irradiation section. Thereby, color noise can be suppressed and a change in the apparent thickness of a line of a character and/or graphics can be suppressed.

An input section for inputting a value of the intensity of light to be emitted by the light irradiation section, may be provided. The luminance levels of the basic portion and the neighboring portion of a character and/or graphics can be set in accordance with the intensity input by a user or viewer through the input section.

This input includes, for example, switching of the on/off state of the light irradiation section and setting of the irradiation level of the light irradiation section.

The luminance level of the basic portion and the luminance level of the neighboring portion of characters and/or graphics may be set in accordance with information related to a viewer of a display device.

The luminance level may be set in accordance with a viewer's age or the state of viewer's eyes (e.g., cataracts), or viewer's preference (e.g., a viewer likes characters and/or graphics displayed with thick lines or dark colors for easy perception), or a combination thereof, input through the input section.

The memory section for storing correction patterns may be provided. A plurality of tables indicating correction patterns depending on the intensity of light for irradiating the display screen are previously stored in the memory section. The tables are selected in accordance with the intensity of light for irradiating the display screen. By selecting the tables in this manner, it is possible to easily change the correction patterns.

A correction pattern is provided, which is used for the case where the intensity (brightness) of light of the light irradiation section (e.g., a backlight, a frontlight, or a sidelight) to the display screen is maximum. Another correction pattern is provided, which is used for the case where the light intensity is minimum. A correction pattern for a case where the light intensity is neither maximum nor minimum, can be calculated based on the above-described two correction patterns. In this case, the memory section stores only the correction patterns for the case where the light intensity (brightness) is maximum and the case where the light intensity is minimum.

Thus, correction patterns can be switched in accordance with the intensity of light for irradiating the display screen. Therefore, as is different from conventional technology, it is not necessary to provide a sensor for sensing ambient brightness.

The luminance levels of the basic portion and the neighboring portion of a character and/or graphics are set in accordance with information related to a viewer of the display device.

The information related to a viewer of the display device includes, for example, a viewer's age or the state of viewer's eyes (e.g., cataracts), or viewer's preference (e.g., a viewer likes characters and/or graphics displayed with thick lines or dark colors for easy perception), or a combination thereof. Such information may be input through the input section. The luminance levels may be set in accordance with such information.

A plurality of tables indicating correction patterns depending on information related to a viewer of the display device may be previously provided in the memory section. By selecting and referencing the table in accordance with the information related to a viewer of the display device, correction patterns can be easily switched.

Thus, the invention described herein makes possible the advantage of providing a display apparatus and display control method, in which the occurrence of color noise and/or an apparent change in a line of a character and/or graphics, caused by the intensity of light for irradiating a display screen, can be suppressed, and characters and/or graphics can be displayed at high definition; a program for executing the display control method on a computer; and a recording medium storing the program.

These and other advantages of the present invention will become apparent to those skilled in the art upon reading and understanding the following detailed description with reference to the accompanying figures.

### BRIEF DESCRIPTION OF THE DRAWINGS

FIG. 1A is a block diagram showing a major part of a configuration of a display apparatus according to an embodiment of the present invention.

FIG. 1B is a block diagram showing a major part of a configuration of a display apparatus according to another embodiment of the present invention.

FIG. 2 is a schematic diagram showing an exemplary display screen in a display device of FIG. 1A formed of pixels.

FIG. 3 is a diagram showing an exemplary correction pattern table stored in an auxiliary memory device of FIG. 1A.

FIG. 4 is a diagram showing an exemplary correction pattern table stored in the auxiliary memory device of FIG. 1A, which is used when a light irradiation section is turned on.

FIG. 5 is a diagram showing an exemplary correction pattern table stored in the auxiliary memory device of FIG. 1A, which is used when the light irradiation section is turned off.

FIG. 6 is a diagram showing an exemplary correction pattern table stored in the auxiliary memory device of FIG. 1A, which is used when the light irradiation section is at irradiation level 4.

FIG. 7 is a diagram showing an exemplary correction pattern table stored in the auxiliary memory device of FIG. 1A, which is used when the light irradiation section is at irradiation level 3.

FIG. 8 is a diagram showing an exemplary correction pattern table stored in the auxiliary memory device of FIG. 1A, which is used when the light irradiation section is at irradiation level 2.

FIG. 9 is a diagram showing an exemplary correction pattern table stored in the auxiliary memory device of FIG. 1A, which is used when the light irradiation section is at irradiation level 1.

FIG. 10 is a flowchart showing an exemplary procedure of a character/graphics display program of FIG. 1A.

FIG. 11 is another flowchart showing another exemplary procedure of the character/graphics display program of FIG. 1A.

FIG. 12 is a diagram showing a character “/” (slash) displayed by a conventional technique, where the character is represented by a basic portion thereof whose color element level is set to a predetermined luminance level.

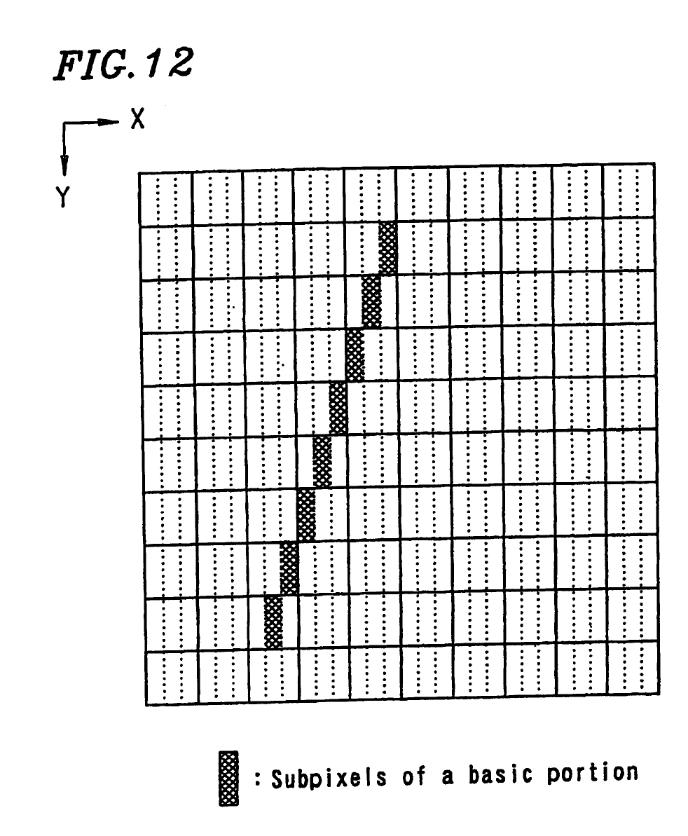

FIG. 13 is a diagram showing the character “/” (slash) displayed by another conventional technique, where the color element level of the basic portion is set to a predetermined luminance level (luminance level 0) and the color element level of the neighboring portion is set to a luminance level different from the luminance level (“0”) of the basic portion.

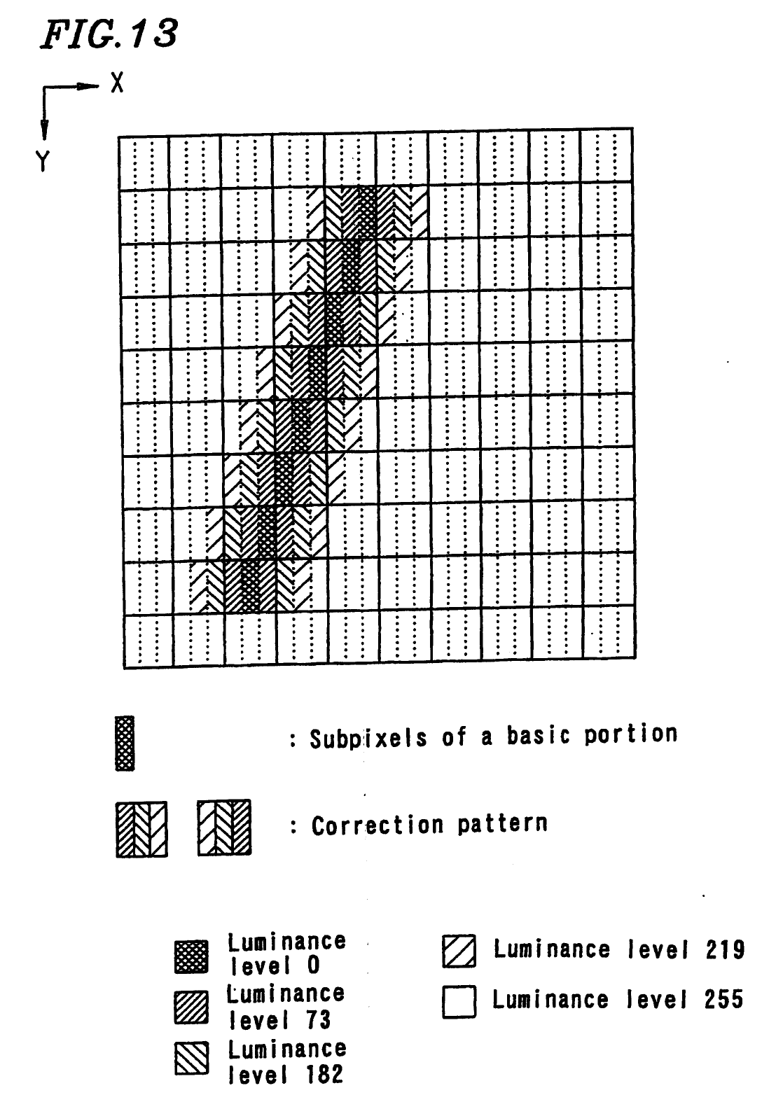

### BEST MODE FOR CARRYING OUT THE INVENTION

Hereinafter, the present invention will be described by way of illustrative examples with reference to the accompanying drawings.

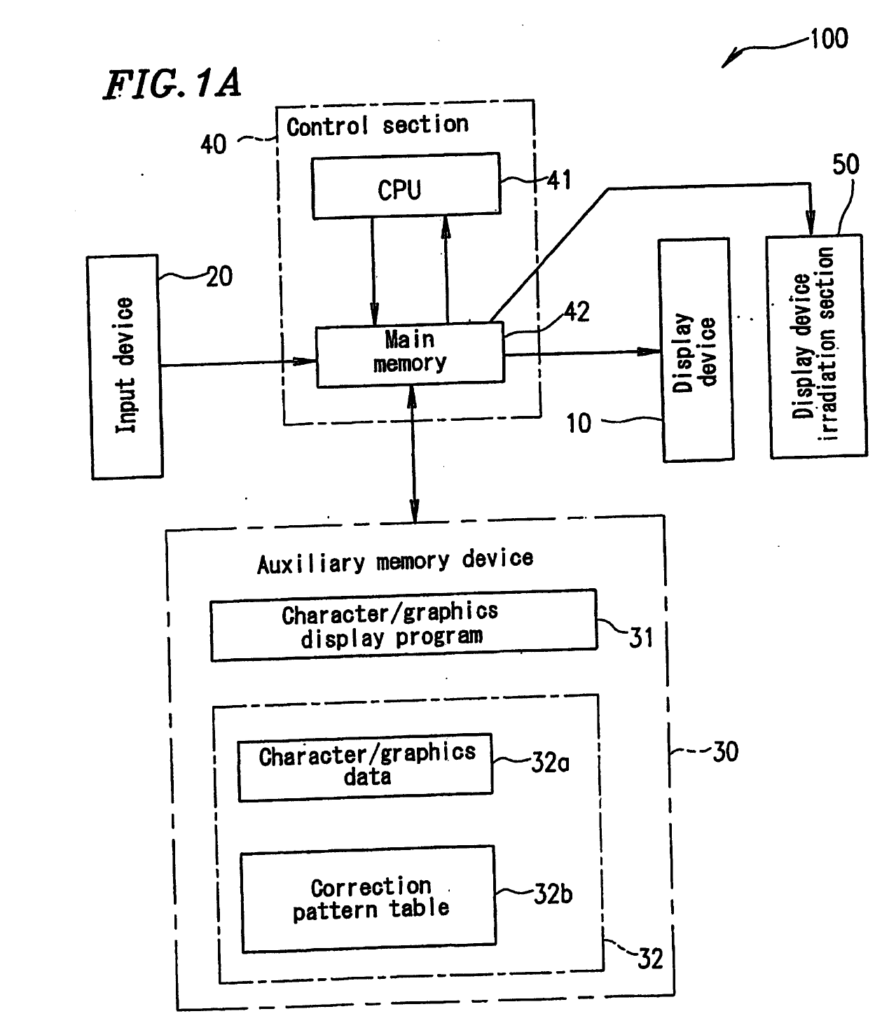

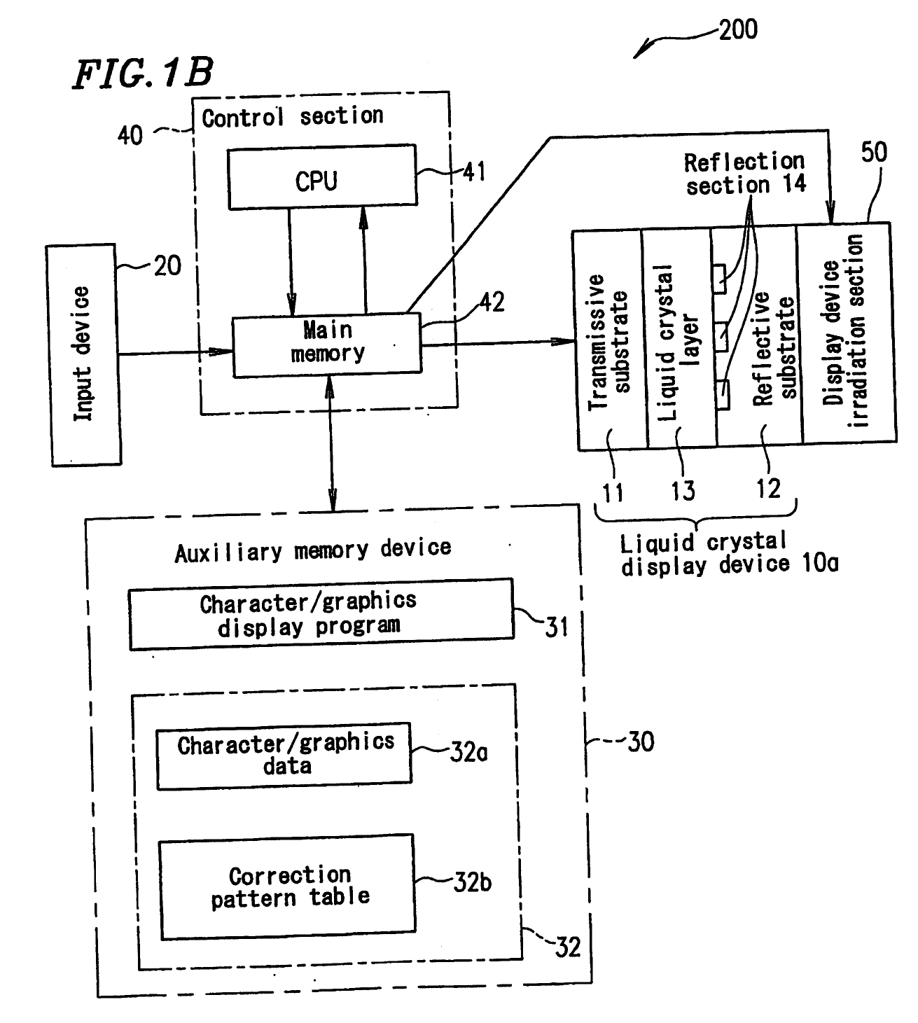

FIG. 1A is a block diagram showing a major part of a configuration of a display apparatus according to an embodiment of the present invention.

Characters and/or graphics displayed by the display apparatus are made of a basic portion corresponding to the core of the character and/or graphics (central skeleton) and a neighboring portion provided in the vicinity of the basic portion.

In FIG. 1A, a display apparatus 100 comprises a display device 10 capable of color display, an input device 20 through which display information is input to the display apparatus 100, an auxiliary memory device 30 which stores a control program and data, a control section 40 for controlling the display device 10, and a display device irradiation section 50 for irradiating a display screen of the display device 10 with light.

The display device 10 can display one or more characters and/or graphics.

The control section 40 controls the display device 10 so that various information input through the input device 20 is displayed in accordance with the control program and data stored in the auxiliary memory device 30.

Information representing characters (including symbols) and/or graphics or information relating to a viewer of the display device 10 may be input through the input device 20 to the display apparatus 100.

The display apparatus 100 may be used as a display apparatus for a personal computer or a word processor, for example. The display apparatus 100 may be used as a desktop or laptop display apparatus or other various types of display apparatus.

The display apparatus 100 may be incorporated into any information apparatus, such as an electronic apparatus. For example, the display apparatus 100 may be used in mobile information instruments (e.g., personal digital assistants and the like), mobile telephones (e.g., PHS (personal handyphone system) and the like), and communication apparatuses (e.g., typical telephones, facsimile machines, and the like).

The display device 10 displays information, such as characters and graphics, which are input through the input device 20.

The input device 20 is used to input information representing characters and graphics to be displayed on the display device 10. This information representing characters and graphics contains, for example, identification codes for identifying the characters and graphics and sizes indicating the dimensions of characters or graphics. Therefore, any input device through which identification codes and the sizes of characters or graphics can be input, can be used as the input device 20.

Preferable examples of the input device 20 include keyboards, mouses, pen-type input devices, and the like. When the display apparatus 100 is a display apparatus of a mobile telephone, number keys for specifying telephone numbers or a microphone for inputting voice may be used as the input device 20 to enter character codes and character sizes.

When characters or graphics displayed on the display device 10 all have a single fixed size, the input of the size may be omitted. Further, when the display apparatus 100 is used as a display section of an information apparatus provided with a communication line connecting section for connecting to a communication line, such as the Internet and the like, messages included in electronic mail received over the communication line may be displayed on the display device 10. In this case, the communication line connecting section may act as the input device 20.

The auxiliary memory device 30 stores: a character/graphics display program 31 as a control program, in which a procedure for displaying characters and/or graphics on a display screen of the display device 10 is described; and data 32 required for executing the character/graphics display program 31. As the auxiliary memory device 30, any readable recording medium may be used to store the character/graphics display program 31 and the data 32, including, for example, hard disk, CD-ROM, MOD, MD, DVD, IC card, optical card, and the like.

The auxiliary memory device 30 functions as a memory section for storing a plurality of correction pattern tables indicating the luminance levels of a basic portion and a neighboring portion.

The character/graphics display program 31 carries out the steps of: setting a predetermined value to the color element level of a subpixel corresponding to the basic portion of a character or graphics in accordance with a change in characteristics of the display device 10 caused by a change in irradiation conditions (e.g., the on/off state of the display device irradiation section 50 or a change in the irradiation level); setting a predetermined value to the respective color element levels of subpixels of the neighboring portion; and displaying the characters or graphics on a display screen. The color element levels of subpixels in a neighboring portion may be set to values which are changed stepwise from the predetermined color element level of the subpixel of the basic portion, depending on the distance from the basic portion in a horizontal direction and/or a vertical direction.

The character/graphics display program 31 may comprise a step of setting the color element level of a basic portion and the color element levels of subpixels in the neighboring portion, based on viewer-related information input through the input device 20 by a user or viewer. Viewer-related information includes, for example, the viewer's age or the state of the viewer's eyes (e.g., cataract) or the viewer's preference (e.g., the viewer likes characters or graphics displayed with thick lines for easy perception).

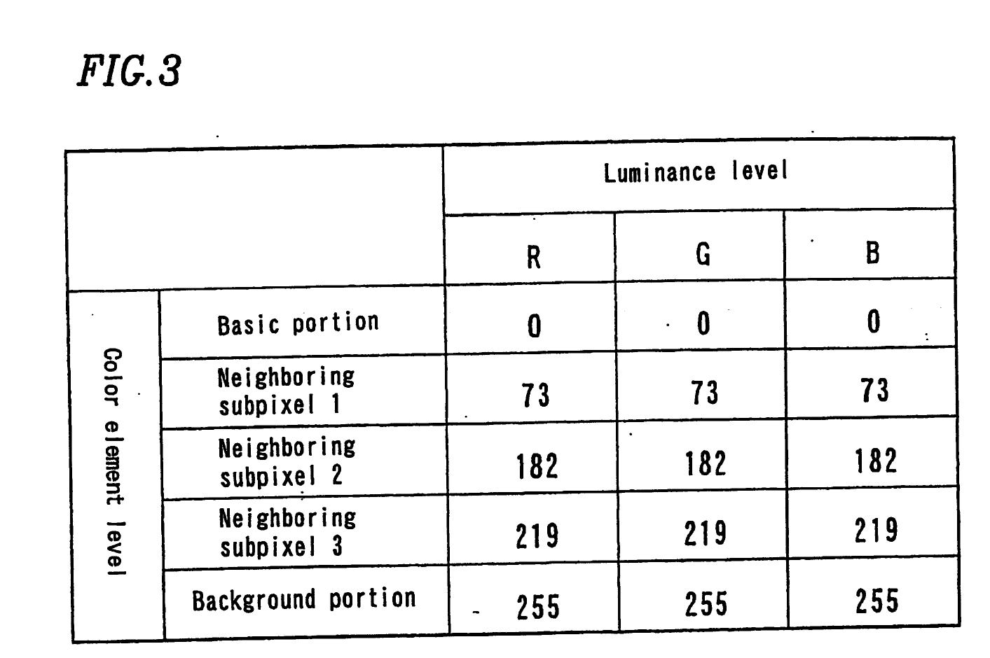

The data 32 contain character/graphics data 32a defining shapes of characters and/or graphics, and a correction pattern table 32b described below in detail (FIG. 3).

The character/graphics data 32a include, for example, bitmap data (basic portion data) defining basic portions of characters and/or graphics in subpixels.

Note that, in the above description, the character/graphics display program 31 and the data 32 are stored in the auxiliary memory device 30 (e.g., a recording medium). The present invention is not limited to this.

For example, the character/graphics display program 31 and the data 32 may be stored in a main memory 42 or a ROM (not shown). Examples of ROM include, for example, mask ROM, EPROM, EEPROM, flash ROM, and the like. When the character/graphics display program 31 and the data 32 are stored in a ROM, a wide variety of programs and data can be easily performed by changing ROMs. Such a ROM scheme can be preferably applied to, for example, the case where the display apparatus 100 is a display section of a mobile terminal or a mobile telephone.

The recording medium for storing the character/graphics display program 31 and the data 32 may be a storage medium which stores programs and data, such as a memory, a semiconductor memory, or the like, which have a disk or card shape.

The recording medium for storing the character/graphics display program 31 and the data 32 may be a communication medium which is used to transmit programs and data over a communication network, i.e., which transmits programs and data.

When the display apparatus 100 is incorporated with an electronic information apparatus comprising a communication line connecting section for connecting to a communication line, such as the Internet, at least a part of the character/graphics display program 31 and the data 32 can be downloaded via the communication line. In this case, a loader program required for download may be provided in an ROM (not shown). Alternatively, such a program may be installed into the main memory 42 of the control section 40 from the auxiliary memory device 30.

The control section 40 comprises a CPU (central processing unit) 41 and a main memory 42. The control section 40 determines the color element levels of subpixels contained in a display screen of the display device 10 and controls the display device 10 to display characters and/or graphics on the display screen, based on the character/graphics display program 31 and the data 32. Specifically, the control section 40 separately controls a plurality of color element levels set to to a plurality of subpixels arranged on the display screen of the display device 10 to display information representing characters and/or graphics input through the input device 20 on the display device 10.

The CPU 41 controls and monitors the display apparatus 100 as well as executing various control programs, such as the character/graphics display program 31 stored in the auxiliary memory device 30, and the like. The CPU 41 determines the color element levels of the basic portion and the neighboring portion of a character or graphics in accordance with light irradiation intensity with respect to a display screen or viewer-related information based on the character/graphics display program 31 or the data 32 stored in the main memory 42 to generate the character or graphics patterns. The generated pattern is temporarily stored in the main memory 42, and thereafter, is output as display data to the display device 10. The timing of outputting the character or graphics patterns to the display device 10 is controlled by the CPU 41.

The main memory 42 is a working memory for temporarily storing data input through the input device 20, data to be displayed on the display screen of the display device 10, and the character/graphics display program 31 and data required to execute the character/graphics display program 31. The main memory 42 may be accessed by the CPU 41 at a high rate.

The display device irradiation section 50 irradiates the display screen of the display device 10 with light. The display device irradiation section 50 may be, for example, a backlight, a frontlight, a sidelight, or the like. The light intensity (brightness) of the display device irradiation section 50 can be controlled in an on/off manner or in a stepwise or sequential manner in accordance with an operating input through the input device 20. The display device irradiation section 50 may also be controlled so that the display device irradiation section 50 is automatically turned on when the display apparatus 100 is switched on or data is input to the input device 20, and after a predetermined period of time, the display device irradiation section 50 is automatically turned off.

FIG. 1B is a block diagram showing a major part of a configuration of a display apparatus according to another embodiment of the present invention.

A display apparatus 200 shown in FIG. 1B is substantially the same as the display apparatus 200 of FIG. 1A, except that a liquid crystal display device 10a is used instead of the display device 10.

In the display apparatus 200, a display device irradiation section 50 is disposed behind the liquid crystal display device 10a.

The liquid crystal display device 10a comprises a transmissive substrate 11, a reflective substrate 12, a liquid crystal layer 13 interposed between the transmissive substrate 11 and the reflective substrate 12.

The reflective substrate 12 is provided with a reflection section 14 for reflecting light which has been transmitted through the transmissive substrate 11 and the liquid crystal layer 13.

Light emitted by the display device irradiation section 50 is also transmitted through a region of the reflective substrate 12 on which the reflection section 14 is not provided, and is further transmitted through the liquid crystal layer 13 and the transmissive substrate 11. The light is used for display of the liquid crystal display device 10a.

The CPU 41 of the control section 40 turns on the display device irradiation section 50 when the surrounding environment is dark, so that the display device irradiation section 50 irradiates the display screen with light and the liquid crystal display device 10a performs display in the transmission mode. When the surrounding environment is bright, the display device irradiation section 50 is turned off to reduce power consumption. In this case, ambient light incoming to the display screen 11 is reflected by the reflection section 14 so that the liquid crystal display device 10a performs display in the reflection mode. Thus, two display modes are switched.

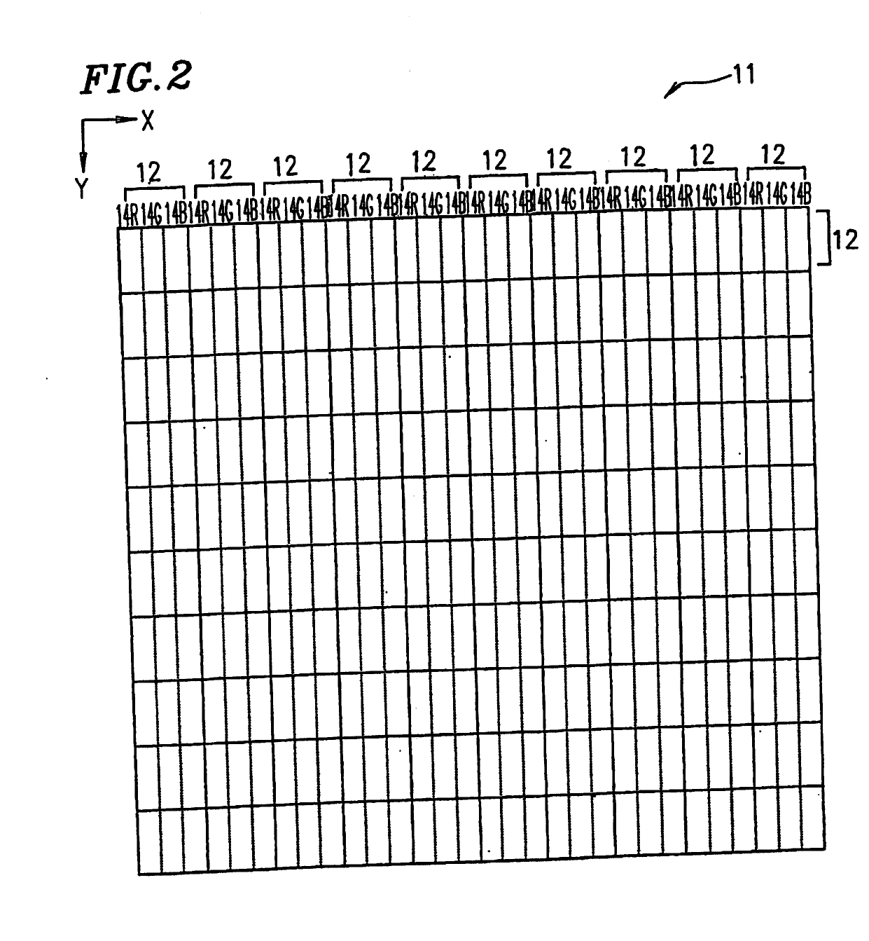

FIG. 2 is a schematic diagram showing an exemplary display screen in the display device 10 of FIG. 1A.

The display device 10 is, for example, a color liquid crystal display device.

In FIG. 2, a display screen 11 of the display device 10 has a plurality of pixels 12 in a matrix having an X direction and a Y direction. Each pixel 12 has a plurality of subpixels arranged in the X direction. Here, each pixel has three subpixels corresponding to three primary colors (i.e., subpixel 14R, 14G, 14B).

The subpixel 14R is previously set to a color element R so as to exhibit a red color (R). The subpixel 14G is previously set to a color element G so as to exhibit a green color (G). The subpixel 14B is previously set to a color element B so as to exhibit a blue color (B).

The color element levels (e.g., luminance levels) of the subpixels 14R, 14G, and 14B are represented by a value of, for example, 0 to 255 (0x00 to 0xff where the notation “0x” represents the hexadecimal number system). If the subpixels 14R, 14G, and 14B separately take any luminance level of 0 to 255, about 16,700,000 (=256×256×256) colors can be displayed.

Examples of the display device 10 include transmissive liquid crystal display devices predominantly used for personal computers and the like, as well as reflective or rear-projection liquid crystal display devices. The display device 10 is not limited to color liquid crystal display devices. As the display device 10, any color display apparatus having a plurality of pixels arranged in the X and Y directions (e.g., XY matrix display apparatus) can be used.

The number of subpixels contained in a single pixel 12 is not limited to 3 (three primary colors). A single pixel 12 may contain a plurality of subpixels arranged in a predetermined direction. For example, when N color elements are used to represent colors, a single pixel 12 may contain N subpixels.

The arrangement sequence of the subpixels 14R, 14G, and 14B is not limited to that shown in FIG. 2. For example, the sequence of B, G and R in that order in the X direction may be used instead of the sequence of R, G, and B in that order.

The direction of the arrangement of the subpixels 14R, 14G, and 14B is not limited to the direction shown in FIG. 2 (the X direction). Alternatively, the subpixels 14R, 14G, and 14B may be arranged in the Y direction.

Color elements applicable to the present invention are not limited to red (R), green (G), and blue (B). For example, cyan (C), yellow (Y), and magenta (M) may be used as color elements.

FIG. 3 is a diagram showing a correction pattern table 321b which is an example of the correction pattern table 32b stored in the auxiliary memory device 30 of FIG. 1A.

In the following description, a process for displaying either a character or graphics on the display screen 11 of the display device 10 will be described.

By storing the correction pattern table 321b of FIG. 3 in the auxiliary memory device 30 (FIG. 1A), the color element level (the luminance level of a color element) of a subpixel can be easily changed.

The control section 40 assigns “0” (black) to the color element level (luminance level) of subpixels corresponding to the basic portion of a character or graphics. Also, the control section 40 assigns “luminance level 73”, “luminance level 182”, and “luminance level 219” to the color element levels of subpixels 1 to 3 neighboring a subpixel corresponding to the basic portion of a character or graphics, in order of distance from the basic portion, the nearest first, in accordance with the correction pattern table 32b. The control section 40 assigns “luminance level 255” to the color element level of subpixels corresponding to the background of the character or graphics.

Note that subpixel (s) of a neighboring portion refers to subpixel(s) which are located in the X direction or −X direction (horizontal direction) relative to a subpixel of the basic portion and within a distance equal to the length of the correction pattern where the distance is defined by the number of subpixels counted in the X or −X direction from the subpixel of the basic portion to the neighboring pixel. When subpixels are arranged in the Y direction within a pixel, subpixel(s) of a neighboring portion refer to subpixel(s) which are located in the Y direction or −Y direction (vertical direction) relative to a subpixel of the basic portion and within a distance equal to the length of the correction pattern where the distance is defined by the number of subpixels counted in the Y or −Y direction from the subpixel of the basic portion to the neighboring pixel.

Thus, the correction pattern table 32b is used to set the color element level (luminance level) of a subpixel in a neighboring portion arranged in the vicinity of a subpixel corresponding to the basic portion of a character or graphics. A neighboring portion contains at least one subpixel.

The color element level of a subpixel in a neighboring portion is defined in accordance with the distance from a subpixel corresponding to the basic portion of a character or graphics. For example, the color element level of subpixels of a neighboring portion of a character or graphics is designed to be monotonically increased as the distance from the basic portion of the character or graphics increases. In an exemplary increasing manner, the color element levels of neighboring subpixels 1 to 3 are set to “luminance level 73”, “luminance level 182”, and “luminance level 219” in the correction pattern table 321b of FIG. 3.

Here, the neighboring subpixel 1 is the nearest of the subpixels in a neighboring portion to a subpixel of the basic portion. The neighboring subpixel 2 is a subpixel that is the second nearest to the subpixel of the basic portion. The neighboring subpixel 3 is a subpixel that is the third nearest to the subpixel of the basic portion.

In the correction pattern table 321b of FIG. 3, subpixels 1 to 3 in a neighboring portion have the same set of color element levels (luminance levels) irrespective of the color elements R, G, and B. However, a different set of luminance levels may be provided for each color element. For example, taking the characteristics of a display device for each of color elements R, G, and B into account, the luminance levels of color element levels may be appropriately set.

Further, in the correction pattern table 321b of FIG. 3, three neighboring subpixels (neighboring subpixels 1 to 3) are provided for a subpixel corresponding to the basic portion of a character or graphics. The present invention is not limited to this. For example, there may be four neighboring subpixels for a subpixel corresponding to a basic portion.

The correction pattern table 321b of FIG. 3 is used when a display attribute of a character or graphics is “normal display”. As used herein, the term “normal display” refers to display in which the background is displayed as being white and characters or graphics are displayed as being black. The present invention is not limited to this.

The display attribute of a character or graphics may be “reverse display”. As used herein, the term “reverse display” refers to display in which the background is displayed as being black and the character or graphics is displayed as being white.

When the display attribute of a character or graphics is “reverse display”, the permutation of the luminance levels corresponding to the color element level in the correction pattern table 321b may be reversed for each color element R, G, and B.

Note that the display attribute of a character or graphics refers to a combination of the color of the background of the character or graphics and the color of the character or graphics. By providing an appropriate correction pattern table 32b, it is possible to display characters or graphics with any display attribute.

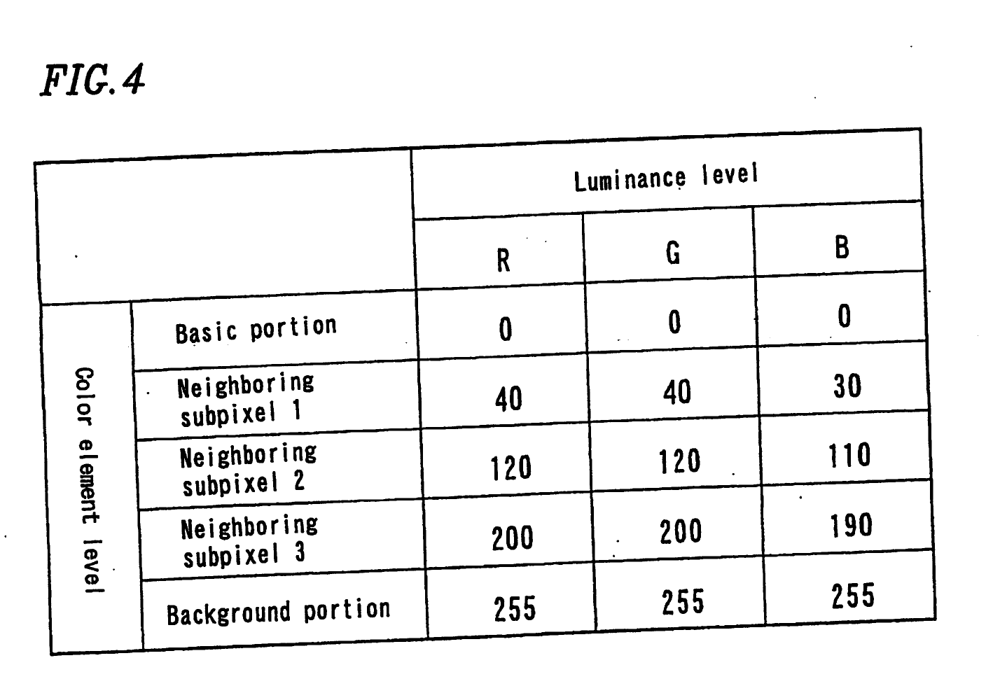

FIG. 4 is a diagram showing a correction pattern table 322b which is another example of the correction pattern table 32b stored in the auxiliary memory device 30 of FIG. 1A. The correction pattern table 322b is used when the display device irradiation section 50 (e.g., a backlight) is on.

The CPU 41 of the control section 40 reads the correction pattern table 322b from the auxiliary memory device 30 to the main memory 42, when the display device irradiation section 50 (e.g., a backlight) is turned on. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 322b as follows. For color element R and color element G, the subpixels of the neighboring portion are set to “luminance level 40”, “luminance level 120”, and “luminance level 200” in order of distance from the basic portion, the nearest first. For color element B, the subpixels of the neighboring portion are set to “luminance level 30”, “luminance level 110”, and “luminance level 190” in order of distance from the basic portion, the nearest first. For color elements R, G and B, the color element levels of subpixels in the background of the character or graphics are set to “luminance level 255”.

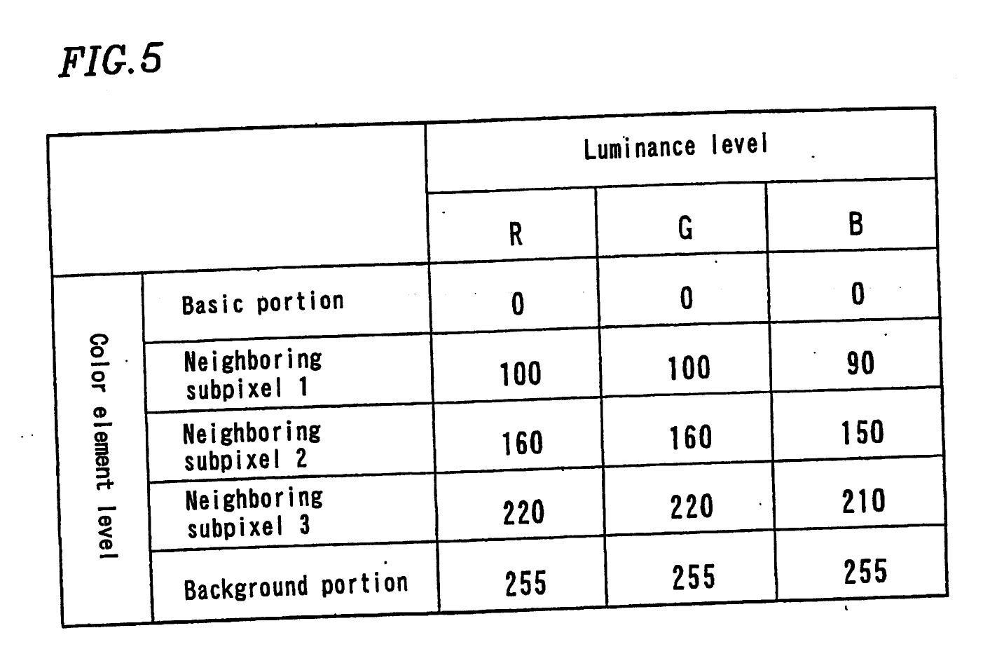

FIG. 5 is a diagram showing a correction pattern table 323b which is another example of the correction pattern table 32b stored in the auxiliary memory device 30 of FIG. 1A.

The correction pattern table 323b is used when the display device irradiation section 50 (e.g., a backlight) is off.

When the display device irradiation section 50 (e.g., a backlight) is turned off, the CPU 41 of the control section 40 reads the correction pattern table 323b from the auxiliary memory device 30 to the main memory 42. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 323b as follows. For color element R and color element G, the subpixels of the neighboring portion are set to “luminance level 100”, “luminance level 160”, and “luminance level 220” in order of distance from the basic portion, the nearest first. For color element B, the subpixels of the neighboring portion are set to “luminance level 90”, “luminance level 150”, and “luminance level 210” in order of distance from the basic portion, the nearest first. For color elements R, G and B, the color element levels of subpixels in the background of the character or graphics are set to “luminance level 255”.

Comparing the correction pattern table 322b of FIG. 4 with the correction pattern table 323b of FIG. 5, the basic portion of a character or graphics and the background portion have the same luminance levels, and the neighboring subpixels 1 to 3 in the neighboring portion of a character or graphics have different values. The luminance levels provided by the correction pattern table 322b (FIG. 4) are lower than the corresponding luminance levels provided by the correction pattern table 323b (FIG. 5). Therefore, by reducing the luminance levels (toward “0” (black)) when the backlight is turned on, the display of the neighboring subpixels 1 to 3 are caused to be closer to black, so that a line of a character or graphics is perceived as being darker. As a result, a change in the apparent thickness of a line in a character or graphics can be prevented.

Note that in the correction pattern table 322b of FIG. 4 and the correction pattern table of FIG. 5, only the luminance levels of the neighboring subpixels 1 to 3 are corrected. The present invention is not limited to this. In the present invention, at least one of the luminance level of the basic portion and the luminance level of the neighboring portion may be corrected.

Note that regarding the correction pattern table 322b (FIG. 4) and the correction pattern table 323b (FIG. 5), a backlight is switched on or off as an example. In the case where a frontlight or a sidelight is switched on/off, similar correction pattern tables can be provided.

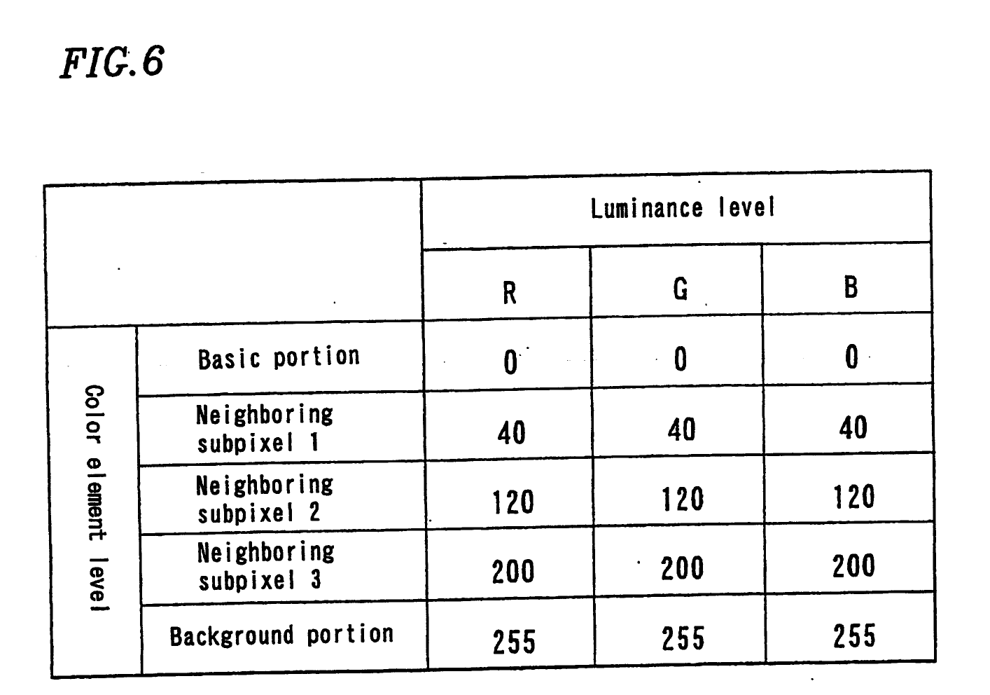

FIG. 6 is a diagram showing a correction pattern table 324b which is another example of the correction pattern table 32b stored in the auxiliary memory device 30 of FIG. 1A. The correction pattern table 324b is used when the intensity of light of the display device irradiation section 50 (e.g., a backlight) is the highest (hereinafter referred to as level 4).

When the intensity of light of the display device irradiation section 50 (e.g., a backlight) is at level 4, the CPU 41 of the control section 40 reads the correction pattern table 324b from the auxiliary memory device 30 to the main memory 42. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 324b as follows. The subpixels of the neighboring portion are set to “luminance level 40”, “luminance level 120”, and “luminance level 200” in order of distance from the basic portion, the nearest first. The color element levels of subpixels in the background of the character or graphics are set to “luminance level 255”.

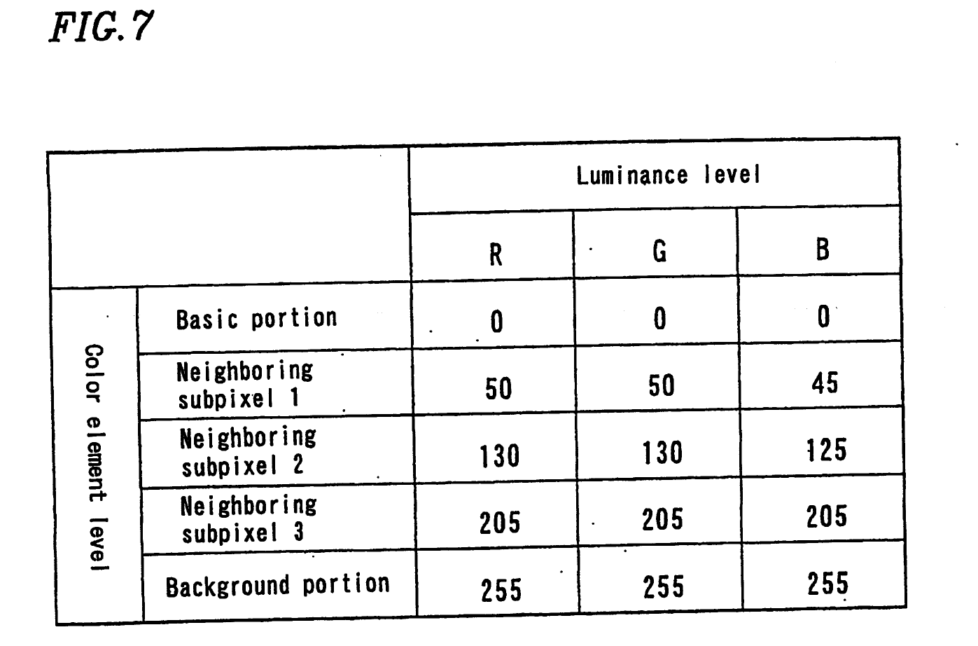

FIG. 7 is a diagram showing a correction pattern table 325b which is another example of the correction pattern table 32b stored in the auxiliary memory device 30 of FIG. 1A. The correction pattern table 325b is used when the intensity of light of the display device irradiation section 50 (e.g., a backlight) is the second highest (hereinafter referred to as level 3).

When the intensity of light of the display device irradiation section 50 (e.g., a backlight) is at level 3, the CPU 41 of the control section 40 reads the correction pattern table 325b from the auxiliary memory device 30 to the main memory 42. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 325b as follows. For color element R and color element G, the subpixels of the neighboring portion are set to “luminance level 50”, “luminance level 130”, and “luminance level 205” in order of distance from the basic portion, the nearest first. For color element B, the subpixels of the neighboring portion are set to “luminance level 45”, “luminance level 125”, and “luminance level 205” in order of distance from the basic portion, the nearest first. For color elements R, G and B, the color element levels of subpixels in the background of the character or graphics are set to “luminance level 255”.

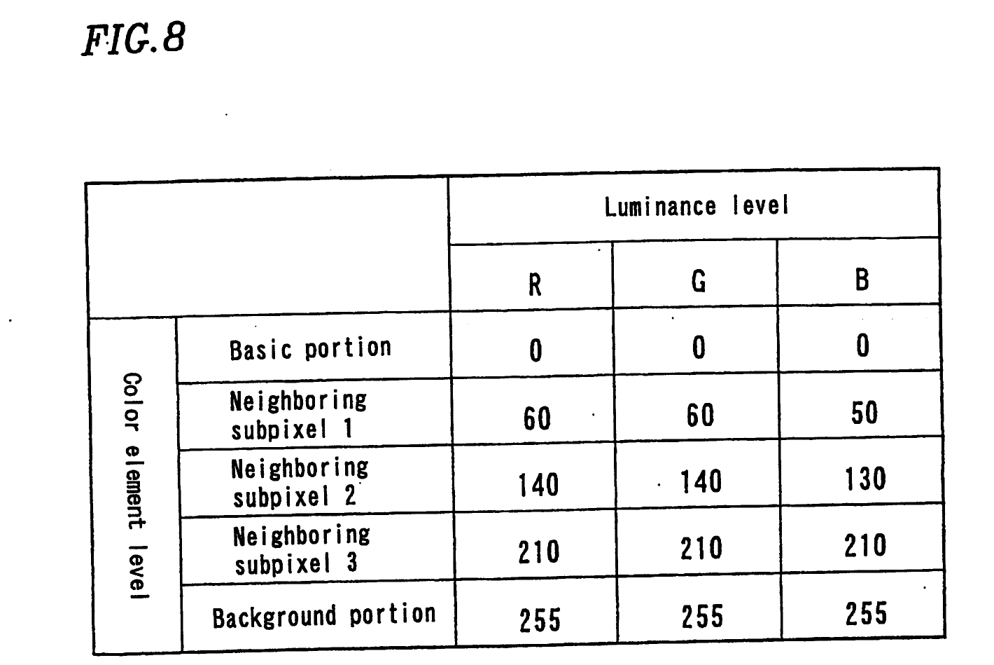

FIG. 8 is a diagram showing a correction pattern table 326b which is another example of the correction pattern table 32b stored in the auxiliary memory device 30 of FIG. 1A. The correction pattern table 326b is used when the intensity of light of the display device irradiation section 50 (e.g., a backlight) is the second lowest (hereinafter referred to as level 2).

When the intensity of light of the display device irradiation section 50 (e.g., a backlight) is at level 2, the CPU 41 of the control section 40 reads the correction pattern table 326b from the auxiliary memory device 30 to the main memory 42. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 326b as follows. For color element R and color element G, the subpixels of the neighboring portion are set to “luminance level 60”, “luminance level 140”, and “luminance level 210” in order of distance from the basic portion, the nearest first. For color element B, the subpixels of the neighboring portion are set to “luminance level 50”, “luminance level 130”, and “luminance level 210” in order of distance from the basic portion, the nearest first. For color elements R, G and B, the color element levels of subpixels in the background of the character or graphics are set to “luminance level 255”.

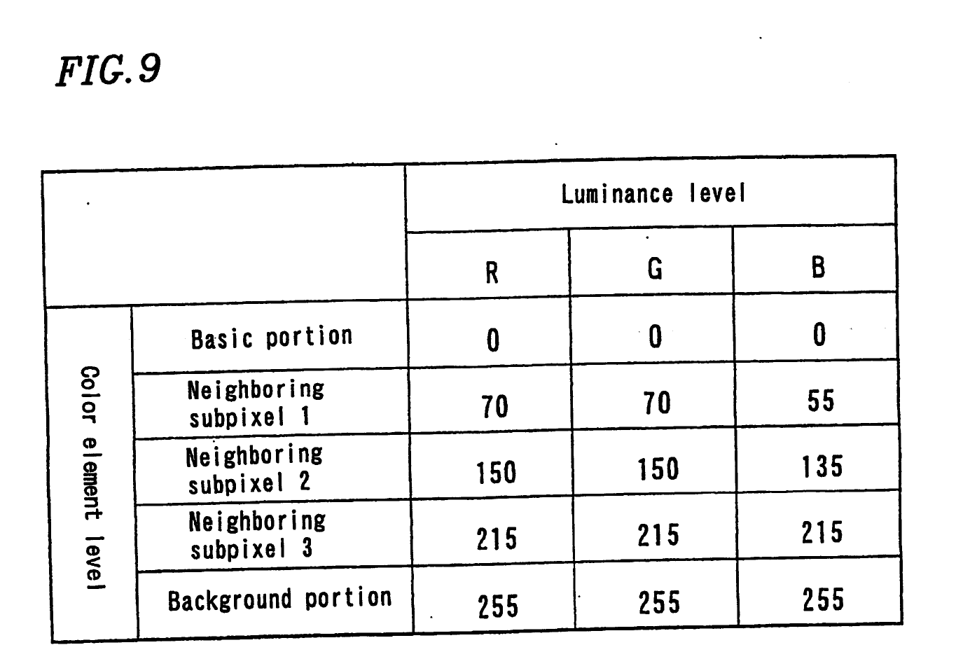

FIG. 9 is a diagram showing a correction pattern table 327b which is another example of the correction pattern table 32b stored in the auxiliary memory device 30 of FIG. 1A. The correction pattern table 327b is used when the intensity of light of the display device irradiation section 50 (e.g., a backlight) is the lowest (hereinafter referred to as level 1).

When the intensity of light of display device irradiation section 50 (e.g., a backlight) is at level 1, the CPU 41 of the control section 40 reads the correction pattern table 327b from the auxiliary memory device 30 to the main memory 42. The color element levels of subpixels corresponding to the basic portion of a character or graphics are set to “luminance level 0”. The color element levels of neighboring subpixels 1 to 3 in the neighboring portion of the character or graphics are set to values in accordance with the correction pattern table 327b as follows. For color element R and color element G, the subpixels of the neighboring portion are set to “luminance level 70”, “luminance level 150”, and “luminance level 215” in order of distance from the basic portion, the nearest first. For color element B, the subpixels of the neighboring portion are set to “luminance level 55”, “luminance level 135”, and “luminance level 215” in order of distance from the basic portion, the nearest first. For color elements R, G and B, the color element levels of subpixels in the background of the character or graphics are set to “luminance level 255”.

Comparing the correction pattern tables 324b to 327b of FIGS. 6 to 9, the basic portion of a character or graphics and the background portion have the same luminance levels, and the neighboring subpixels 1 to 3 in the neighboring portion of a character or graphics have different values. As the intensity of light from a backlight increases, i.e., the backlight becomes brighter, the luminance level is reduced.

By reducing the luminance levels (toward “0” (black)) when the intensity of light from a backlight is large, the display of the neighboring subpixels 1 to 3 are caused to be closer to black, so that a line of a character or graphics is perceived as being darker, i.e., thicker. As a result, a change in the apparent thickness of a line in a character or graphics can be prevented.

Further, comparing the correction pattern tables 324b to 327b of FIGS. 6 to 9, as the intensity of light from a backlight is decreased, i.e., the backlight becomes darker, blueness increases. Therefore, the luminance level of color element B is set to be lower than the luminance level of color element R and color element G.

For the correction pattern tables 324b to 327b of FIGS. 6 to 9, the intensity of light of a backlight is set to have four levels (i.e., levels 1 to 4). The present invention is not limited to this. When the intensity of light of a backlight has N levels (N: natural number of 2 or more), N correction pattern tables corresponding to the respective levels need to be provided.

Color element levels (luminance levels) are set for the correction pattern tables 324b to 327b of FIGS. 6 to 9, assuming that blueness increases with an increase in the intensity of light of a backlight. The present invention is not limited to this. Redness or greenness may increase, depending on the characteristics of a display device. In this case, color element levels are set so that uniform colors can be displayed in accordance with the characteristics of a display device.

For the correction pattern tables 324b to 327b of FIGS. 6 to 9, the intensity of light of a backlight is controlled as an example. The intensity of light of a frontlight or a sidelight may be controlled in accordance with similar correction pattern tables.

Note that in the correction pattern tables 324b to 327b of FIGS. 6 to 9, only the luminance levels of the neighboring subpixels 1 to 3 are corrected. The present invention is not limited to this. In the present invention, at least one of the luminance level of the basic portion and the luminance level of the neighboring portion may be corrected.

In the thus-configured display apparatus 100 of an embodiment of the present invention, the CPU 41 of the control section 40 executes a predetermined character/graphics display program 31. According to the character/graphics display program 31, for example, no matter whether the display device irradiation section 50 is turned on or off, color noise can be reduced and a change in the apparent thickness of a line of a character and/or graphics can be suppressed. As a result, characters and/or graphics can be displayed at high definition. A character/graphics display control method executed by the character/graphics display program 31 will be described below.

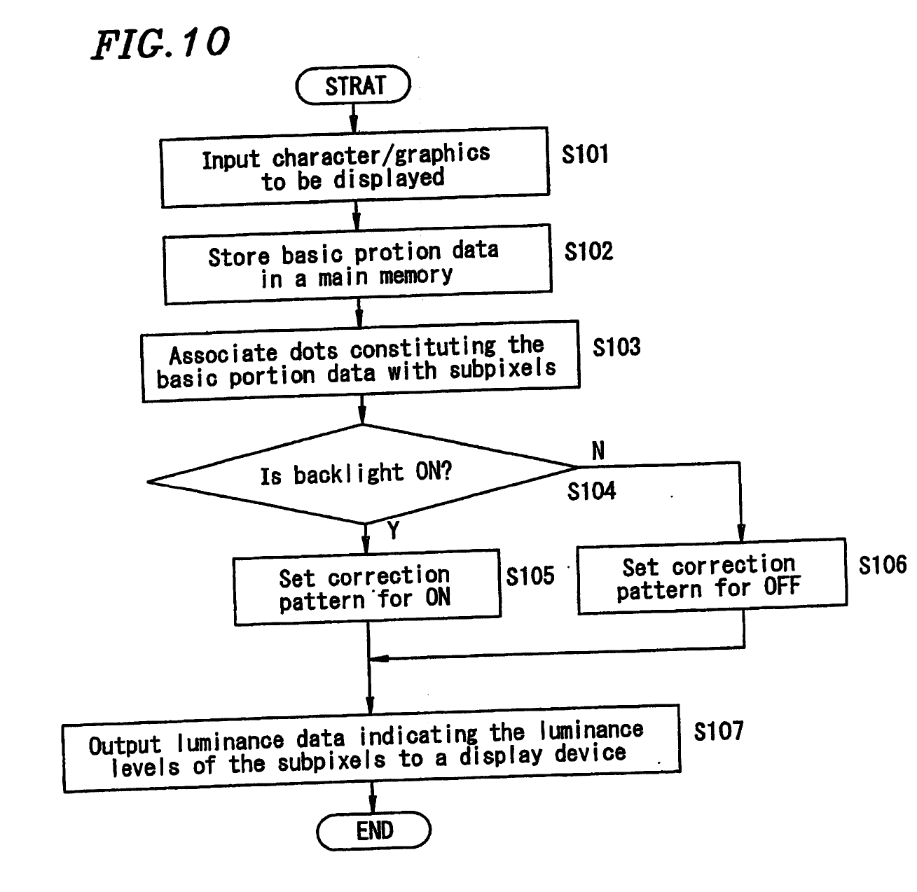

FIG. 10 is a flowchart of the character/graphics display program 31, which is executed by the control section 40.

As shown in FIG. 10, in step S101, information relating to a character or graphics to be displayed on the display screen of the display device 10 is input. In this case, for example, the identification code and size of the character or graphics are input through the input device 20.

Next, in step S102, the basic portion data of the character or graphics corresponding to the input identification code and size is obtained and stored temporarily in the main memory 42.

Data associated with a basic portion is herein referred to as basic portion data.

The basic portion data may be bitmap data which defines the basic portion of the character or graphics in subpixels. Dots constituting the basic portion data correspond to respective subpixels.

The basic portion data is obtained by reading out the character/graphics data 32a from the auxiliary memory device 30, for example.

Alternatively, as disclosed in Japanese Laid-Open Publication No. 2002-49366, the basic portion data may be generated from bitmap data representing the shape of a character or graphics in pixels.

Alternatively, as disclosed in Japanese Laid-Open Publication No. 2001-100725, the basic portion data may be generated from character or graphics outline information indicating the outlines of characters or graphics or skeleton data indicating the skeleton shapes of characters or graphics.

In step S103, each dot constituting the basic portion data is associated with a subpixel in the display screen 11 (FIG. 2) of the display device 10. This association is executed by taking into account the position of a character displayed on the display screen 11 of the display device 10. For example, when a character is displayed at the upper left corner of the display screen 11, the dot at the upper left corner constituting the basic portion data is associated with a subpixel at the upper left corner of the display screen 11.

In step S104, it is determined whether the display device irradiation section 50 (e.g., a backlight) is on or off.

When the display device irradiation section 50 (e.g., a backlight) is on, i.e., the result of determination in step S104 is “Yes”, the procedure goes to step S105. When the display device irradiation section 50 (e.g., a backlight) is off, i.e., the result of determination in step S104 is “No”, the procedure goes to step S106.

In step S105 (the display device irradiation section 50 (e.g., a backlight) is on), the correction pattern table 322b (FIG. 4) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 322b.

In step S106 (the display device irradiation section 50 (e.g., a backlight) is off), the correction pattern table 323b (FIG. 5) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 323b.

After step S105 or step S106, luminance data indicating the luminance level of each of a plurality of subpixels is transferred to the display device 10 in step S107. The luminance levels of subpixels of the display screen 11 of the display device 10 are controlled in accordance with the luminance data, so that a character or graphics is displayed on the display screen 11.

According to the above-described character/graphics display control method, the luminance levels are lower when a backlight is on than when the backlight is off, so that displayed characters or graphics have darker lines. Therefore, the line width of displayed characters or graphics appears to be larger. Thus, it is possible to suppress a change in the apparent thickness of a line of a character or graphics between when a backlight is on and when the backlight is off. In either case of the on or off state of the backlight, the luminance level of color element B is set to be lower than the luminance level of color element R and color element G in accordance with characteristics of a liquid crystal display device, thereby making it possible to suppress color noise.

In the thus-configured display apparatus 100 of an embodiment of the present invention, the CPU 41 of the control section 40 executes the character/graphics display program 31 in another manner as follows. Even if the intensity of light emitted by the display device irradiation section 50 onto the display screen 11 is changed, color noise can be reduced and a change in the apparent thickness of a line of a character and/or graphics can be suppressed. As a result, characters and/or graphics can be displayed at high definition. A character/graphics display control method executed by the character/graphics display program 31 will be described below.

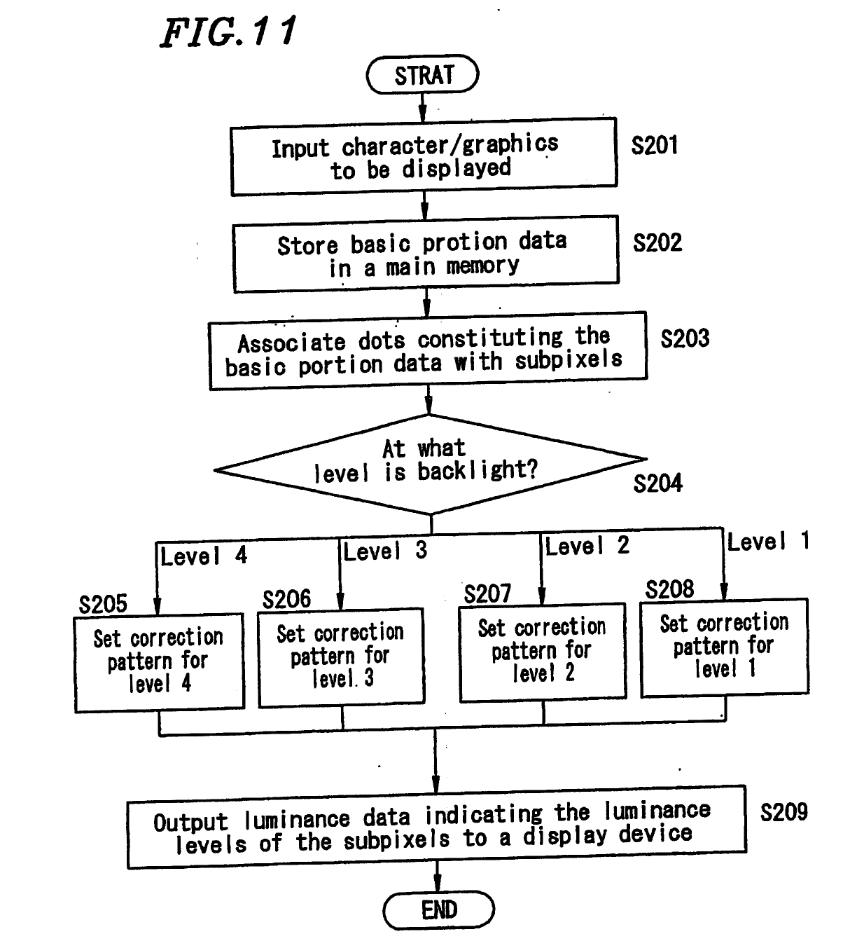

FIG. 11 is another flowchart of the character/graphics display program 31 (FIG. 1A), which is executed by the control section 40.

As shown in FIG. 11, in step S201, information relating to a character or graphics to be displayed on the display screen 11 of the display device 10 is input. Step S201 is performed in a manner similar to that in step S101 of FIG. 10.

Next, in step S202, the basic portion data of the character or graphics corresponding to the input identification code and size is obtained and stored temporarily in the main memory 42. Step S202 is performed in a manner similar to that in step S102 of FIG. 10.

In step S203, each dot constituting the basic portion data is associated with a subpixel in the display screen 11 (FIG. 2) of the display device 10. Step S203 is performed in a manner similar to that in step S103 of FIG. 10.

In step S204, the brightness (irradiation level) of the display device irradiation section 50 (e.g., a backlight) is determined.

In this embodiment, the display device irradiation section 50 has four levels of brightness (irradiation levels) i.e., level 1 (lowest) to level 4 (highest). The level currently selected can be detected based on a level selection signal indicating a level which has been selected. When the irradiation level of the backlight is level 4, the procedure goes to step S205. When the irradiation level of the backlight is level 3, the procedure goes to step S206. When the irradiation level of the backlight is level 2, the procedure goes to step S207. When the irradiation level of the backlight is level 1, the procedure goes to step S208.

In step S205 (the brightness (irradiation level) of the display device irradiation section 50 (e.g., a backlight) is level 4), the correction pattern table 324b (FIG. 6) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 324b.

In step S206 (the brightness (irradiation level) of the display device irradiation section 50 (e.g., a backlight) is level 3), the correction pattern table 325b (FIG. 7) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 325b.

In step S207 (the brightness (irradiation level) of the display device irradiation section 50 (e.g., a backlight) is level 2), the correction pattern table 326b (FIG. 8) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 326b.

In step S208 (the brightness (irradiation level) of the display device irradiation section 50 (e.g., a backlight) is level 1), the correction pattern table 327b (FIG. 9) is selected from the data 32 stored in the auxiliary memory device 30. The luminance levels of subpixels corresponding to the basic portion of a character or graphics, the luminance level of subpixels in a neighboring portion arranged in the vicinity of the basic portion, and the luminance levels of subpixels corresponding to the background of the character or graphics, are set to values in accordance with the selected correction pattern table 327b.

After step S205, S206, S207, or step S208, luminance data indicating the luminance level of each of a plurality of subpixels is transferred to the display device 10 in step S209. In accordance with the luminance data, the luminance levels of the display screen 11 of the display device 10 are controlled in subpixels, so that a character or graphics is displayed on the display screen 11.

According to this character/graphics display control method, the lower luminance levels are displayed when the irradiation level of a backlight is greater (brighter) than when the irradiation level of the backlight is smaller (darker). Therefore, displayed characters or graphics have darker lines. Therefore, the line width of a displayed character or graphics appears to be larger. Thus, it is possible to suppress a change in the apparent thickness of a line of a character or graphics, even when the irradiation level of a backlight is changed.

As the irradiation level of a backlight is decreased, i.e., the backlight becomes darker, blueness increases due to the characteristics of a liquid crystal display device. Therefore, the luminance level of color element B is set to be lower than the luminance level of color element R and color element G. Thus, it is possible to suppress color noise.

Next, a method for preparing correction patterns will be described when the display device irradiation section 50 has N irradiation levels (brightness levels), where N is an integer of 3 or more. In the auxiliary memory device 30, a correction pattern table for the case when the irradiation level (brightness) of the display device irradiation section 50 is the height, and a correction pattern table for the case when the irradiation level (brightness) of the display device irradiation section 50 is the lowest, are previously provided. For other irradiation levels, correction patterns are calculated based on these two tables. Hereinafter, a calculation method will be described.

Now it is assumed as follows. The display device irradiation section 50 has N irradiation levels (brightness levels). When the irradiation level is 1 (lowest), the luminance levels of neighboring subpixels 1 corresponding to respective color elements R, G, and B are Rmin1, Gmin1, and Bmin1, respectively, and similarly, the luminance levels of neighboring subpixels 2 corresponding to respective color elements R, G, and B are Rmin2, Gmin2, and Bmin2, respectively. Similarly, the luminance levels of neighboring subpixels 3 corresponding to respective color elements R, G, and B are Rmin3, Gmin3, and Bmin3, respectively.

Further, when the irradiation level is N (height), the luminance levels of neighboring subpixels 1 corresponding to respective color elements R, G, and B are Rmax1, Gmax1, and Bmax1, respectively. Similarly, the luminance levels of neighboring subpixels 2 corresponding to respective color elements R, G, and B are Rmax2, Gmax2, and Bmax2, respectively. Similarly, the luminance levels of neighboring subpixels 3 corresponding to respective color elements R, G, and B are Rmax3, Gmax3, and Bmax3, respectively.

When the irradiation level (brightness) of the display device irradiation section 50 is M where M is an integer which is greater than or equal to 1 and smaller than or equal to N, the luminance level of color element R of the neighboring subpixel 1 is represented by Rm1, the luminance level of color element G of the neighboring subpixel 1 is represented by Gm1, and the luminance level of color element B of the neighboring subpixel 1 is represented by Bm1. Each value is calculated as follows.
Rm1=((Rmin1−Rmax1)/(N−1))×(M−1)+Rmin1
Gm1=((Gmin1−Gmax1)/(N−1))×(M−1)+Gmin1
Bm1=((Bmin1−Bmax1)/(N−1))×(M−1)+Bmin1

Similarly, the luminance level of color element R of the neighboring subpixel 2 is represented by Rm2, the luminance level of color element G of the neighboring subpixel 2 is represented by Gm2, and the luminance level of color element B of the neighboring subpixel 2 is represented by Bm2. Each value is calculated as follows.
Rm2=((Rmin2−Rmax2)/(N−1))×(M−1)+Rmin2
Gm2=((Gmin2−Gmax2)/(N−1))×(M−1)+Gmin2
Bm2=((Bmin2−Bmax2)/(N−1))×(M−1)+Bmin2

Similarly, the luminance level of color element R of the neighboring subpixel 3 is represented by Rm3, the luminance level of color element G of the neighboring subpixel 3 is represented by Gm3, and the luminance level of color element B of the neighboring subpixel 3 is represented by Bm3. Each value is calculated as follows.
Rm3=((Rmin3−Rmax3)/(N−1))×(M−1)+Rmin3
Gm3=((Gmin3−Gmax3)/(N−1))×(M−1)+Gmin3
Bm3=((Bmin3−Bmax3)/(N−1))×(M−1)+Bmin3

The luminance level of a subpixel corresponding to the basic portion of a character or graphics, and the luminance level of a subpixel corresponding to the background portion, are constant irrespective of the irradiation level (brightness) of the display device irradiation section 50.

As described above, the correction pattern table for the case when the irradiation level (brightness) of the display device irradiation section 50 is the highest, and the correction pattern table for the case when the irradiation level (brightness) of the display device irradiation section 50 is the lowest, are stored in the auxiliary memory device 30. Correction patterns for irradiation levels between the highest irradiation level and the lowest irradiation level are obtained by calculation. Thus, it is possible to provide a correction pattern for any of the irradiation levels (brightness levels).

In the above-described calculation, a correction pattern (e.g., luminance levels) corresponding to an irradiation level between the highest irradiation level and the lowest irradiation level, is obtained by linear interpolation. The present invention is not limited to this. Any function which is dependent on the characteristics of the display device 10 may be used.

The case where a backlight is used as the display device irradiation section 50 is described above. The present invention is not limited to this. In the present invention, for example, a frontlight, a sidelight, or the like, may be provided as the display device irradiation section 50.

In the above-described embodiments, the luminance levels of the basic portion and neighboring portion of characters and/or graphics are set in accordance with the intensity of light for irradiating the display screen 11. The present invention is not limited to this.

In the present invention, the luminance levels of the basic portion and neighboring portion of characters and/or graphics may be set in accordance with information related to a viewer of the display device 10.

Specifically, some user or viewer of the display device 10 may have difficulty in viewing the display of characters and graphics, for example, due to the condition of the user's eyes (e.g., cataracts). In such a situation, a correction pattern table suitable for such a user may be provided and stored in the auxiliary memory device 30. This correction pattern table may be selected based on a user's instruction input through the input device 20. The luminance levels (correction pattern) of subpixels corresponding to a basic portion and subpixels corresponding to a neighboring portion may be set in accordance with the correction pattern table.

Further, the luminance levels of the basic portion and the neighboring portion of characters and/or graphics may be set based on both the intensity of light emitted onto the display screen 11 and information related to a viewer of the display device 10.

According to the above-described embodiments, the color element levels (luminance levels) of subpixels corresponding to the basic portion and the neighboring portion of a character and/or graphics are set in accordance with a correction pattern which is provided by considering the on/off state or irradiation levels of the display device irradiation section 50. For example, when the level of irradiation of the display device 10 is great, the luminance levels of the subpixels in a neighboring portion are set to be low. In this case, a line of a character and/or graphics is perceived as being darker, i.e., the line appears to be thicker. As a result, a change in the apparent thickness of a line in a character and/or graphics can be prevented. Therefore, by setting the luminance levels of subpixels in accordance with the irradiation intensity (on/off state or irradiation level) to the display screen 11, color noise can be suppressed and a change in the apparent thickness of a line of a character or graphics can be suppressed, resulting in high-definition display of the character and/or graphics. Thus, as is different from conventional technology, a sensor for detecting the intensity of light need not be provided around the display device 10.

In the above-described embodiments, the display device is capable of displaying colors. The present invention is not limited to this. The present invention can be applied to any display device capable of displaying gray levels. The display device may be capable of displaying only black and white.

In the above-described embodiments, the luminance level of a neighboring portion is corrected in accordance with the intensity of light for irradiating a display screen or information related to a viewer of a display device. The present invention is not limited to this. In the present invention, by correcting the luminance level of the basic portion of a character or graphics, color noise can be suppressed and a change in the apparent thickness of a line of the character and/or graphics can be suppressed, resulting in the high-definition display of the character and/or graphics.

### INDUSTRIAL APPLICABILITY

According to the present invention, the luminance levels of the basic portion and the neighboring portion of a character and/or graphics are set in accordance with the intensity of light for irradiating a display screen (e.g., the on/off state of a light irradiation section or the irradiation level of the light irradiation section). Therefore, it is possible to provide a correction pattern suitable for a change in the characteristic of a display device caused by the on/off state of the light irradiation section or a change in the irradiation level. As a result, color noise can be suppressed and a change in the apparent thickness of a line of a character and/or graphics caused by ambient brightness can be suppressed.

Further, correction pattern tables are stored in a memory section. By selecting one of the correction pattern tables in accordance with the intensity of light for irradiating a display screen, correction patterns can be easily switched. Thus, as is different from conventional technology, a sensor for sensing ambient brightness is not required.

Furthermore, characters and/or graphics can be displayed in a manner which is suitable for a viewer in accordance with information related to a viewer of a display device (e.g., the viewer's age, eye condition, or the like).

Furthermore, correction pattern tables are stored in a memory section. By selecting one of the correction pattern tables in accordance with viewer-related information, correction patterns can be easily switched.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A display apparatus, comprising:
a display device including a display screen for displaying characters and/or graphics, wherein each of the characters and/or graphics contains a basic portion and a neighboring portion arranged in the vicinity of the basic portion; and
a control section for controlling the display device,
wherein the control section sets a luminance level of the basic portion and a luminance level of the neighboring portion in accordance with the intensity of light for irradiating the display screen, and
the control section controls the display device so that the character and/or graphics are displayed on the display screen using the set luminance level of the basic portion and the set luminance level of the neighboring portion.

2. A display apparatus according to claim 1, wherein the control section corrects at least one of the luminance level of the basic portion and the luminance level of the neighboring portion in accordance with the intensity of light for irradiating the display screen.

3. A display apparatus according to claim 1, wherein the control section sets the luminance level of the neighboring portion so that the luminance level of the neighboring portion is changed stepwise with an increase in a distance from the basic portion.

4. A display apparatus according to claim 1, wherein the control section sets the luminance level of the basic portion and the luminance level of the neighboring portion based on luminance levels of a plurality of color elements.

5. A display apparatus according to claim 1, wherein the display screen contains a plurality of pixels;
each of the plurality of pixels contains a plurality of subpixels; and
each of the plurality of subpixels is associated with one of a plurality of color elements.

6. A display apparatus according to claim 5, wherein the basic portion and the neighboring portion are assigned the plurality of subpixels.

7. A display apparatus according to claim 1, further comprising:
a light irradiation section for irradiating the display screen with light,
wherein the control section sets the luminance level of the basic portion and the luminance level of the neighboring portion in accordance with the intensity of light to be emitted from the light irradiation section to the display screen.

8. A display apparatus according to claim 7, wherein the control section sets the luminance level of the basic portion and the luminance level of the neighboring portion in accordance with the on or off state of the light irradiation section.

9. A display apparatus according to claim 7, wherein the control section sets the luminance level of the basic portion and the luminance level of the neighboring portion in accordance with an irradiation level indicating the intensity of light to be emitted from the light irradiation section to the display screen.

10. A display apparatus according to claim 1, further comprising a light irradiation section for irradiating the display screen with light, wherein:
the display device includes a display medium and a reflection section;
the light irradiation section is disposed at a rear of the display medium;
the control section switches between a transmission mode in which light to be emitted from the light irradiation section is transmitted through the display medium when the light irradiation section is on, and a reflection mode in which light incident from a front of the display medium and transmitted through the display medium is reflected by the reflection section when the light irradiation section is off; and
the control section sets the luminance level of the basic portion and the luminance level of the neighboring portion in accordance with the transmission mode or the reflection mode.

11. A display apparatus according to claim 1, further comprising:
a memory section for storing a plurality of correction pattern tables indicating the luminance level of the basic portion and the luminance level of the neighboring portion,
wherein the control section selects one of the plurality of correction pattern tables in accordance with the intensity of light for irradiating the display screen, and sets the luminance level of the basic portion and the luminance level of the neighboring portion in accordance with the selected correction pattern table.

12. A display apparatus according to claim 11, wherein the plurality of correction pattern tables are dependent on the intensity of light for irradiating the display screen.

13. A display apparatus according to claim 7, further comprising:
an input section for setting the intensity of light to be emitted from the light irradiation section.

14. A display apparatus according to claim 1, further comprising:
an input section for inputting information related to a viewer viewing the display device.

15. A display apparatus according to claim 14, wherein the viewer-related information includes at least one of information related to the viewer's age, information related to the viewer's eye condition, and information related to the viewer's preference.

16. A display control method for displaying characters and/or graphics on a display screen, wherein each of the characters and/or graphics contains a basic portion and a neighboring portion arranged in the vicinity of the basic portion, the method comprising the steps of:
setting a luminance level of the basic portion and a luminance level of the neighboring portion in accordance with the intensity of light for irradiating the display screen; and
displaying the character and/or graphics on the display screen using the set luminance level of the basic portion and the set luminance level of the neighboring portion.

17. A display control method according to claim 16, wherein the setting step includes correcting at least one of the luminance level of the basic portion and the luminance level of the neighboring portion in accordance with the intensity of light for irradiating the display screen.

18. A display control method according to claim 16, wherein the setting step includes setting the luminance level of the neighboring portion so that the luminance level of the neighboring portion is changed stepwise with an increase in a distance from the basic portion.

19. A display control method according to claim 16, wherein the setting step includes setting the luminance level of the basic portion and the luminance level of the neighboring portion based on luminance levels of a plurality of color elements.

20. A display control method according to claim 16, wherein the display screen contains a plurality of pixels;
each of the plurality of pixels contains a plurality of subpixels; and
each of the plurality of subpixels is associated with one of a plurality of color elements.

21. A display control method according to claim 16, further comprising the step of:
setting the intensity of light to be emitted from a light irradiation section to the display screen,
wherein the step of setting the luminance levels includes setting the luminance level of the basic portion and the luminance level of the neighboring portion in accordance with the set intensity of light to be emitted from the light irradiation section to the display screen.

22. A program for displaying characters and/or graphics on a display screen, wherein each of the characters and/or graphics contains a basic portion and a neighboring portion arranged in the vicinity of the basic portion, the program instructing a computer to execute the steps of:
setting a luminance level of the basic portion and a luminance level of the neighboring portion in accordance with the intensity of light for irradiating the display screen; and
displaying the character and/or graphics on the display screen using the set luminance level of the basic portion and the set luminance level of the neighboring portion.

23. A recording medium, storing a program for displaying characters and/or graphics on a display screen, wherein each of the characters and/or graphics contains a basic portion and a neighboring portion arranged in the vicinity of the basic portion, the program instructing a computer to execute the steps of:
setting a luminance level of the basic portion and a luminance level of the neighboring portion in accordance with the intensity of light for irradiating the display screen; and
displaying the character and/or graphics on the display screen using the set luminance level of the basic portion and the set luminance level of the neighboring portion.

24. A display apparatus, comprising:
a display device including a display screen for displaying characters and/or graphics, wherein each of the characters and/or graphics contains a basic portion and a neighboring portion arranged in the vicinity of the basic portion; and
a control section for controlling the display device,
wherein the control section sets a luminance level of the basic portion and a luminance level of the neighboring portion in accordance with information related to a viewer of the display device, and
the control section controls the display device so that the character and/or graphics are displayed on the display screen using the set luminance level of the basic portion and the set luminance level of the neighboring portion.

25. A display apparatus according to claim 24, wherein the control section corrects at least one of the luminance level of the basic portion and the luminance level of the neighboring portion in accordance with the viewer-related information.

26. A display apparatus according to claim 24, wherein the viewer-related information includes at least one of information related to the viewer's age, information related to the viewer's eye condition, and information related to the viewer's preference.

27. A display apparatus according to claim 24, wherein the control section sets the luminance level of the neighboring portion so that the luminance level of the neighboring portion is changed stepwise with an increase in a distance from the basic portion.

28. A display apparatus according to claim 24, wherein the control section sets the luminance level of the basic portion and the luminance level of the neighboring portion based on luminance levels of a plurality of color elements.

29. A display apparatus according to claim 24, wherein the display screen contains a plurality of pixels;
each of the plurality of pixels contains a plurality of subpixels; and
each of the plurality of subpixels is associated with one of a plurality of color elements.

30. A display apparatus according to claim 29, wherein the basic portion and the neighboring portion are assigned the plurality of subpixels.

31. A display apparatus according to claim 24, further comprising:
a memory section for storing a plurality of correction pattern tables indicating the luminance level of the basic portion and the luminance level of the neighboring portion,
wherein the control section selects one of the plurality of correction pattern tables in accordance with the viewer-related information, and sets the luminance level of the basic portion and the luminance level of the neighboring portion in accordance with the selected correction pattern table.

32. A display apparatus according to claim 24, further comprising:
an input section for inputting the viewer-related information.

33. A display control method for displaying characters and/or graphics on a display screen, wherein each of the characters and/or graphics contains a basic portion and a neighboring portion arranged in the vicinity of the basic portion, the method comprising the steps of:
setting a luminance level of the basic portion and a luminance level of the neighboring portion in accordance with information related to a viewer of the display screen; and
displaying the character and/or graphics on the display screen using the set luminance level of the basic portion and the set luminance level of the neighboring portion.

34. A display control method according to claim 33, wherein the setting step includes correcting at least one of the luminance level of the basic portion and the luminance level of the neighboring portion in accordance with the viewer-related information.

35. A display control method according to claim 33, wherein the viewer-related information includes at least one of information related to the viewer's age, information related to the viewer's eye condition, and information related to the viewer's preference.

36. A display control method according to claim 33, wherein the setting step includes setting the luminance level of the neighboring portion so that the luminance level of the neighboring portion is changed stepwise with an increase in a distance from the basic portion.

37. A display control method according to claim 33, wherein the setting step includes setting the luminance level of the basic portion and the luminance level of the neighboring portion based on luminance levels of a plurality of color elements.

38. A display control method according to claim 33, wherein the display screen contains a plurality of pixels;
each of the plurality of pixels contains a plurality of subpixels; and
each of the plurality of subpixels is associated with one of a plurality of color elements.

39. A display control method according to claim 33, further comprising the step of:
inputting the viewer-related information.

40. A program for displaying characters and/or graphics on a display screen, wherein each of the characters and/or graphics contains a basic portion and a neighboring portion arranged in the vicinity of the basic portion, the program instructing a computer to execute the steps of:
setting a luminance level of the basic portion and a luminance level of the neighboring portion in accordance with information related to a viewer of the display screen; and
displaying the character and/or graphics on the display screen using the set luminance level of the basic portion and the set luminance level of the neighboring portion.

41. A recording medium, storing a program for displaying characters and/or graphics on a display screen, wherein each of the characters and/or graphics contains a basic portion and a neighboring portion arranged in the vicinity of the basic portion, the program instructing a computer to execute the steps of:
setting a luminance level of the basic portion and a luminance level of the neighboring portion in accordance with information related to a viewer of the display screen; and
displaying the character and/or graphics on the display screen using the set luminance level of the basic portion and the set luminance level of the neighboring portion.
